(19) United States
(12) Patent Application Publication
(10) Pub. No.: US 2015/0379254 A1
(43) Pub. Date: Dec. 31, 2015

(54) AUTHENTICATION SYSTEM THAT UTILIZES BIOMETRIC INFORMATION

(71) Applicant: HITACHI, LTD., Tokyo (JP)

(72) Inventors: Yusuke MATSUDA, Tokyo (JP); Naoto MIURA, Tokyo (JP); Akio NAGASAKA, Tokyo (JP); Takafumi MIYATAKE, Tokyo (JP)

(21) Appl. No.: 14/737,545

(22) Filed: Jun. 12, 2015

(30) Foreign Application Priority Data
Jun. 25, 2014 (JP) 2014-130138

(51) Int. Cl. G06F 21/32; G06K 9/00

(52) U.S. Cl. CPC G06F 21/32; G06K 9/00892

(57) ABSTRACT

The purpose of the present invention is to provide a highly accurate authentication system in a biometric authentication system. The authentication system includes: a measurement device that acquires biometric modality information from a living body of a first user; an input unit that generates at least one item of input information from the biometric modality information; a storage device that stores first feature information acquired from the biometric modality information of the first user, and second feature information acquired based on a correlation between the biometric modality information of the first user and biometric modality information of a second user; and an authentication unit that authenticates the first user by collating the input information with the first feature information and collating the input information with the second feature information.

### CLAIM OF PRIORITY

The present application claims priority from Japanese patent application JP Patent Application No. 2014-130138 filed on Jun. 25, 2014, the content of which is hereby incorporated by reference into this application.

### BACKGROUND

1. Technical Field

The present invention relates to a system that authenticates an individual by utilizing human biometric information.

2. Background Art

As a result of the progress in network technology that has been made in recent years, it is expected that the future demand will increase for cloud type biometric authentication services that centrally manage biometric data for individual authentication over a network. When a plurality of pieces of biometric data can be centrally managed on a server, a vast number of data items may be registered.

When the number of people who utilize a biometric authentication system is large, throughput is decreased in the case of 1:1 authentication whereby a living body is presented after the individual is uniquely identified by the input of a personal identification number or by the presentation of an ID card. Thus, it is desirable to perform so-called 1:N authentication involving solely biometric authentication without utilizing the personal identification number or ID card. As the number of data items registered on a server increases, N in the 1:N authentication increases. Accordingly, in order to correctly distinguish individuals from among a large number of registered data items, increased accuracy is required.

Patent Document 1 discloses a technique aimed at achieving increased accuracy of individual identification performance by utilizing collation of biometric features of an individual with those of others. In Patent Document 1, it is described that the object is to make authentication faster in so-called multimodal authentication involving a plurality of pieces of biometric information for authentication. In Patent Document 1, as a solution for achieving the increase in speed, a multimodal authentication method is described whereby candidates are selected from among registered persons by utilizing first biometric information from the authentication-requesting person, and then collation is performed only with the candidates using second biometric information.

In Patent Document 1, it is further described that a similarity value is detected in the form of an index indicating a similarity relationship between respective pieces of the second biometric information of the candidates on the basis of a predetermined function. In Patent Document 1, if the similarity value based on collation with the others exceeds a predetermined threshold value, candidate selection is performed again. Only when the similarity value is below the predetermined threshold value, it is determined that personal identification from the candidates can be readily performed utilizing the second biometric information, and authentication is performed.

### RELATED ART DOCUMENTS

Patent Document 1: JP 2005-275508 A

### SUMMARY

However, merely increasing the types (biometric modality) of biometric information utilized for biometric authentication does not necessarily lead to an increase in the amount of beneficial information for individual authentication. Namely, for increased accuracy, it is necessary to increase information beneficial for individual identification capacity from among the information obtained from biometric modality. However, it is considered that the biometric features that have been utilized for biometric authentication so far do not fully draw and take advantage of all features inherently possessed by a living body that are beneficial for individual identification. Thus, there is the problem of how to draw feature information beneficial for authentication that has not been used in conventional biometric modality or newly added biometric modality, and to fully take advantage of the feature information for authentication, instead of simply increasing the types of biometric modality.

An object of the present invention is to provide a highly accurate authentication system that utilizes beneficial feature information in a biometric authentication system.

In order to achieve the above object, the configurations set forth in the claims are adopted, for example. The present application includes a plurality of means for solving the problem. For example, there is provided an authentication system including a measurement device that acquires biometric modality information from a living body of a first user; an input unit that generates at least one item of input information from the biometric modality information; a storage device that stores first feature information acquired from the biometric modality information of the first user, and second feature information acquired based on a correlation between the biometric modality information of the first user and biometric modality information of a second user; and an authentication unit that authenticates the first user by collating the input information with the first feature information and collating the input information with the second feature information.

In another example, there is provided an authentication system including a measurement device that acquires biometric modality information from a living body of a first user; an input unit that generates input information from the biometric modality information; a storage device that stores, with respect to a group of at least three persons including the first user, group feature information acquired based on a correlation between the biometric modality information of the at least three persons; and an authentication unit that authenticates the group to which the first user belongs by collating the input information with the group feature information.

In yet another example, there is provided an authentication system including a measurement device that acquires biometric modality information from a living body of a first user; an input unit that generates input information from the biometric modality information; a storage device that stores first feature information acquired from the biometric modality information of the first user and group information indicating a group to which the first user belongs; and an authentication unit that authenticates the first user by collating the input information with the first feature information. The authentication unit authenticates a second user belonging to the group by collating the input information with the first feature information, identifies the group to which the second user belongs, and lowers an authentication condition for the first user for a predetermined time when the first user is at a close spatial distance from the second user and temporally close from an authentication time for the second user.

According to the present invention, a highly accurate authentication system can be provided by utilizing beneficial feature information.

Additional features relating to the present invention will become apparent from the description of the present specification and the attached drawings. Problems, configurations, and effects other than those described above will become apparent from the following description of embodiments.

### BRIEF DESCRIPTION OF THE DRAWINGS

FIG. 1A illustrates an overall configuration of a biometric authentication system according to a first embodiment.

FIG. 1B is a functional block diagram of an authentication processing unit according to the first embodiment.

FIG. 2 illustrates an operation of the biometric authentication system according to the first embodiment.

FIG. 3 is a flowchart of an authentication process according to the first embodiment.

FIG. 4A illustrates a biometric feature extraction method and a biometric feature registration method in the first embodiment.

FIG. 4B illustrates an example of a table in a registration database in the first embodiment

FIG. 5 is a diagram for describing a collation process between registered data in the registration database and input data of an authentication-requesting person in the first embodiment.

FIG. 6 is a diagram for describing an example of extraction of first and second feature information from a finger blood vessel image and registration of the information in the registration database.

FIG. 7 is a diagram for describing a collation process between the authentication-requesting person and biometric features in the registration database in the first embodiment.

FIG. 8A is a diagram for describing a process of registration of the second feature information and extraction property in the second embodiment.

FIG. 8B illustrates an example of a table in the registration database in a second embodiment.

FIG. 9 is a flowchart of an authentication process in the second embodiment.

FIG. 10 is a diagram for describing a collation process between registered data in the registration database and input data of the authentication-requesting person in the second embodiment.

FIG. 11 is a diagram for describing a collation process between registered data in the registration database and input data of the authentication-requesting person in the second embodiment.

FIG. 12 is a diagram for describing an example of extraction of the first feature information, the second feature information, and extraction property from the finger blood vessel image, and their registration in the registration database.

FIG. 13 is a diagram for describing a collation process between the authentication-requesting person and the biometric feature in the registration database in the second embodiment.

FIG. 14 is a flowchart of an authentication process in a third embodiment.

FIG. 15A is a diagram for describing a biometric feature extraction method and a biometric feature registration method in the third embodiment.

FIG. 15B illustrates an example of a table in the registration database in the third embodiment.

FIG. 16 is a diagram for describing a collation process between the authentication-requesting person and the biometric feature in the registration database in the third embodiment.

FIG. 17 is a flowchart of an authentication process in a fourth embodiment.

FIG. 18A is a diagram for describing a biometric feature extraction method and a biometric feature registration method in the fourth embodiment.

FIG. 18B illustrates an example of a table in the registration database in the fourth embodiment.

FIG. 19 is a diagram for describing a collation process between registered data in the registration database and input data of the authentication-requesting person in the fourth embodiment.

FIG. 20 is a flowchart of a first authentication process in a fifth embodiment.

FIG. 21 is a diagram for describing an example of application of the first authentication process in the fifth embodiment to an authentication gate.

FIG. 22 is a flowchart of a second authentication process in a sixth embodiment, the flow being performed after the flow of FIG. 14.

FIG. 23 is a diagram for describing an example of application of the second authentication process in the sixth embodiment to an authentication gate.

FIG. 24 is a diagram for describing an authentication process in a seventh embodiment.

FIG. 25 is a diagram for describing an authentication process in the seventh embodiment.

FIG. 26A illustrates an example of a table in the registration database in the seventh embodiment.

FIG. 26B is a flowchart of an authentication process in the seventh embodiment.

FIG. 27 is a diagram for describing a method of generating a unique ID from a finger blood vessel image in an eighth embodiment

FIG. 28 is a diagram for describing encoding of blood vessel partial patterns in the eighth embodiment.

### DETAILED DESCRIPTION OF EMBODIMENTS

In the following, embodiments of the present invention will be described with reference to the attached drawings. While the attached drawings illustrate specific embodiments in accordance with the principle of the present invention, the embodiments are provided for facilitating an understanding of the present invention and are not to be used for interpreting the present invention in a limited sense.

### First Embodiment

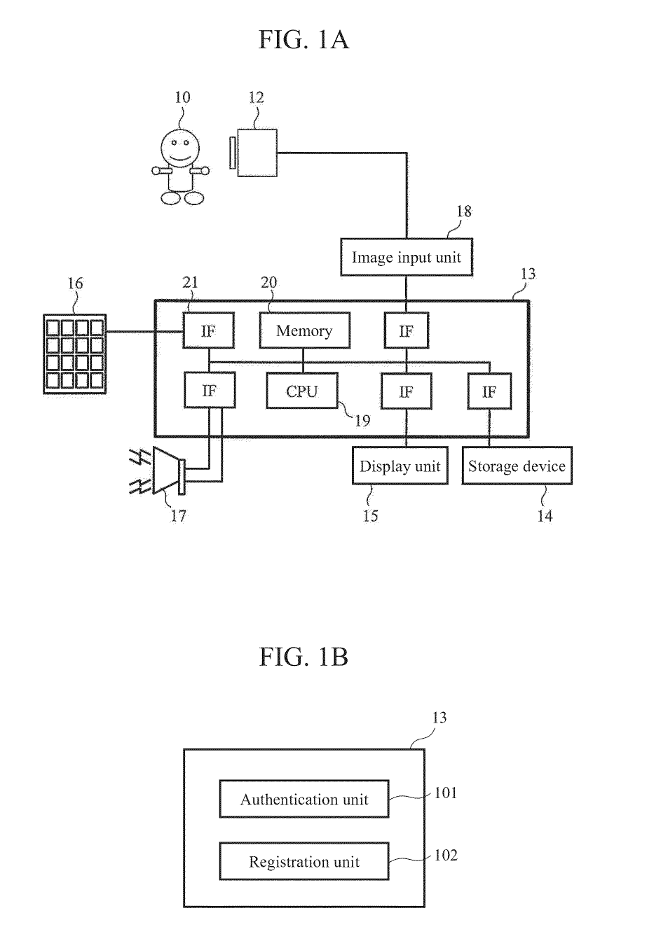

FIG. 1A illustrates an overall configuration of a biometric authentication system according to an embodiment of the present invention. The biometric authentication system includes a measurement device 12, an authentication processing unit 13, a storage device 14, a display unit 15, an input unit 16, a speaker 17, and an image input unit 18.

The measurement device 12 is a device that acquires information about biometric modality of an authentication-requesting person 10, and may include a camera or a distance sensor. In the following, a case will be described in which a biometric modality image of the authentication-requesting person 10 is obtained by the measurement device 12, for example. The image input unit 18 acquires the image of the authentication-requesting person 10 that has been captured by the measurement device 12, generates input data from the acquired image, and sends the data to the authentication processing unit 13. The authentication processing unit 13 includes a CPU 19, a memory 20, and various interfaces (IF) 21. The CPU 19 performs various processes by executing a program recorded in the memory 20. The memory 20 stores the program executed by the CPU 19. The memory 20 also temporarily stores the image input from the input unit 18. The interfaces 21 are provided for connection with devices connected to the authentication processing unit 13. Specifically, the interfaces 21 are connected to the measurement device 12, the storage device 14, the display unit 15, the input unit 16, the speaker 17, and the image input unit 18, for example.

The storage device 14 stores registered data of the authentication-requesting person who utilizes the present system. The registered data include information for collation of the authentication-requesting person, such as an image obtained by measuring a living body of the person. The display unit 15 displays information received from the authentication processing unit 13, for example. The input unit 16, such as a keyboard and mouse, transmits information input by the authentication-requesting person to the authentication processing unit 13. The speaker 17 is a device that emits information received from the authentication processing unit 13 in the form of an acoustic signal.

FIG. 1B is a functional block diagram of the authentication processing unit 13. The authentication processing unit 13 includes an authentication unit 101 and a registration unit 102. The authentication unit 101 performs authentication of the authentication-requesting person 10 by collating the input data input from the image input unit 18 with the registered data registered in the storage device 14. The registration unit 102 extracts, from the image of the biometric modality of the authentication-requesting person 10 that has been acquired by the measurement device 12, first biometric feature information and second biometric feature information as will be described later, and stores the first biometric feature information and the second biometric feature information in a predetermined database in the storage device 14.

The processing units of the authentication processing unit 13 may be realized by various programs. In the memory 20, various programs stored in the storage device 14, for example, are loaded. The CPU 19 executes the programs loaded into the memory 20. The processes and operations described below are executed by the CPU 19.

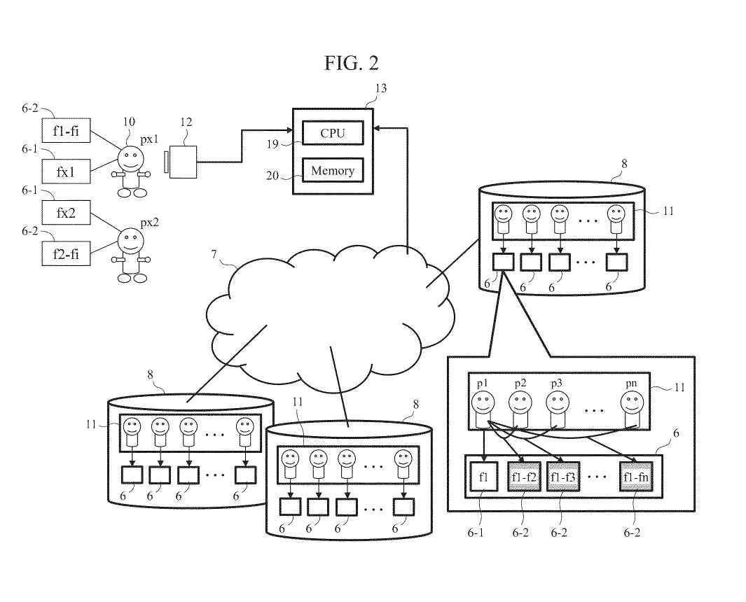

FIG. 2 shows a diagram for describing an operation of the biometric authentication system according to the first embodiment. The biometric authentication system according to the present embodiment provides a cloud type biometric authentication service that centrally manages biometric information for individual authentication on the network 7. In FIG. 2, the storage device 14 of FIG. 1 is implemented as storage devices in servers on the network 7. The authentication processing unit 13 is connected to a plurality of registration databases 8 on a plurality of servers existing on the network 7.

In the biometric authentication system of FIG. 2, the measurement device 12 measures biometric information of the authentication-requesting person 10, and inputs the measured biometric information to the authentication processing unit 13 via a predetermined input unit (such as, in the case of an image, via the image input unit 18). In the image input unit 18, biometric feature information is extracted from the biometric information of the authentication-requesting person 10.

The CPU 19 executes the program stored in the memory 20 to collate the biometric feature information of the authentication-requesting person 10 with biometric feature information 6 of registered persons 11 (p1, p2, . . . , pn; n is the number of people registered in the database) stored in the registration databases 8 connected via the network 7, whereby individual authentication can be performed.

As a feature of the present embodiment, the biometric feature information 6 includes first biometric feature information 6-1 extracted by referring only to the biometric modality information of one person, and second biometric feature information 6-2 acquired on the basis of correlation of biometric modality information between different persons. For example, the second biometric feature information 6-2 is biometric feature information extracted by searching for biometric information having high correlation value (such as similarity) between the biometric modality information items of different persons. The first biometric feature information 6-1 and the second biometric feature information 6-2 may be each extracted from the same biometric modality or from different biometric modalities. The biometric modality for extracting the first biometric feature information 6-1 and the second biometric feature information 6-2 may include blood vessel, fingerprint, palm print, palm shape, nail shape, face, ear shape, iris, retina, gait, or any other biometric modality.

Generally, conventional biometric authentication involves authenticating an individual by utilizing biometric feature information (i.e., information such as the first biometric feature information 6-1) extracted from a living body of the individual in a uniform feature extraction process. However, in the present invention, in addition to the first biometric feature information 6-1 extracted in a uniform process, the second biometric feature information 6-2 having high correlation (such as similarity) between a plurality of persons is extracted and utilized for individual authentication.

The second biometric feature information 6-2 is biometric feature information exhibiting high correlation value indicating a correlation between a plurality of different persons. Herein, the correlation value means the degree of correspondence in biometric modality between a plurality of different persons. For example, when the biometric modality is obtained as an image, the correlation value may include similarity indicating the degree of correspondence between image patterns. The similarity may be calculated by applying a technology well known to those skilled in the art.

“Having high correlation value” means that the correlation value is higher than a certain reference value by a predetermined value. Herein, as the reference value, a standard value (such as an average value) may be obtained from the distribution of the correlation values of biometric modality information between a plurality of different persons. For example, when a biometric modality image is utilized, an image pattern of biometric modality of a certain person is matched with image patterns of biometric modality of various persons, and a similarity histogram is created. In the histogram, a pattern at a position spaced apart from a standard position, such as an average value, by a predetermined value may be extracted as the second biometric feature information 6-2. The method of extracting the second biometric feature information 6-2 is not limited to the above, and other methods may be used for extraction.

The first biometric feature information 6-1 is such that high similarity is obtained by collation with the subject person while low similarity is obtained by collation with the others. Thus, the first biometric feature information 6-1 enables individual authentication by distinguishing the subject person and the others. The first biometric feature information 6-1 is such that low similarity is obtained when collated with most persons other than the subject person. In other words, when the first biometric feature information 6-1 is collated with persons other than the subject person, high similarity is rarely obtained.

On the other hand, the second biometric feature information 6-2 is such that high similarity is obtained when collated with (specific) others, and can provide a unique feature between the collated persons. Specifically, a biometric feature such that high similarity is obtained only between specific persons is intentionally acquired as the second biometric feature information 6-2 and registered in advance. When the second biometric feature information 6-2 is collated with specific others and if high similarity is obtained, the authenticity of the authentication-requesting person as the subject person increases, whereby the person can be distinguished from the others and the individual can be authenticated. Consider a case in which all similarities obtained by collating an arbitrary feature, such as the first biometric feature information 6-1, with others are comprehensively utilized for individual authentication. In this case, as described above, mostly low similarities are obtained in the case of collation with the others, and it is not very effective in improving individual identification performance to utilize a number of low similarities obtained by collation with the others. Accordingly, by intentionally utilizing only the second biometric feature information 6-2 where high similarity is obtained when collated with others for individual authentication, individual identification performance can be improved more effectively than by simply utilizing the similarities obtained by collation with others.

In the present embodiment, the authenticity of the subject person is determined by utilizing the similarity calculated by collation of the registered first biometric feature information 6-1 with the subject person, and the authenticity of the subject person is further determined by utilizing an increase in similarity calculated by collation with the registered second biometric feature information 6-2. In this configuration, individual authentication with increased accuracy can be realized.

In the foregoing, as the second biometric feature information 6-2, the biometric feature information exhibiting high correlation value indicating the correlation between a plurality of different persons is extracted. However, this example is not a limitation, and as the second biometric feature information 6-2, biometric feature information exhibiting low correlation value indicating the correlation between a plurality of different persons may be extracted. “Exhibiting low correlation value” means that the correlation value is lower than a certain reference value by a predetermined value. By the same method as described above, the second biometric feature information 6-2 having low correlation value between a plurality of different persons can be extracted. In this case, it becomes possible to confirm the authenticity of the authentication-requesting person as the subject person by utilizing an extremely low similarity obtained by collation with the second biometric feature information 6-2.

In the following, a more specific example will be described. Referring to FIG. 2, a case in which authentication-requesting persons px1 and px2 are authenticated in a distinguished manner will be described. In this case, it is assumed that when the first biometric feature information 6-1(fx1) of px1 that is input is collated with the first biometric feature information 6-1(f1) of p1 that is registered in the registration databases 8, high similarity is obtained. On the other hand, it is assumed that when the first biometric feature information 6-1(fx2) of px2 that is input is collated with the registered first biometric feature information 6-1(f1) of p1, high similarity is obtained, so that the authentication-requesting persons px1 and px2 cannot be distinguished when authenticated.

Herein, the second biometric feature information 6-2 (f1-fi) having high similarity calculated by collation of person p1 with each person pi (2≦i≦n) other than p1 in the registration database 8 is extracted and registered in advance. When the second biometric feature information 6-2 (f1-fi) is extracted from the input px1, and collated with the second biometric feature information 6-2 (f1-fi) of the registered p1, most of a plurality of similarities obtained exhibit high values. On the other hand, when the second biometric feature information 6-2 (f2-fi) of the input px2 is collated with the second biometric feature information 6-2 (f1-fi) of the registered p1, most of a plurality of similarities that are obtained have low values. Thus, the persons px1 and px2 can be distinguished, and px1 can be authenticated as p1.

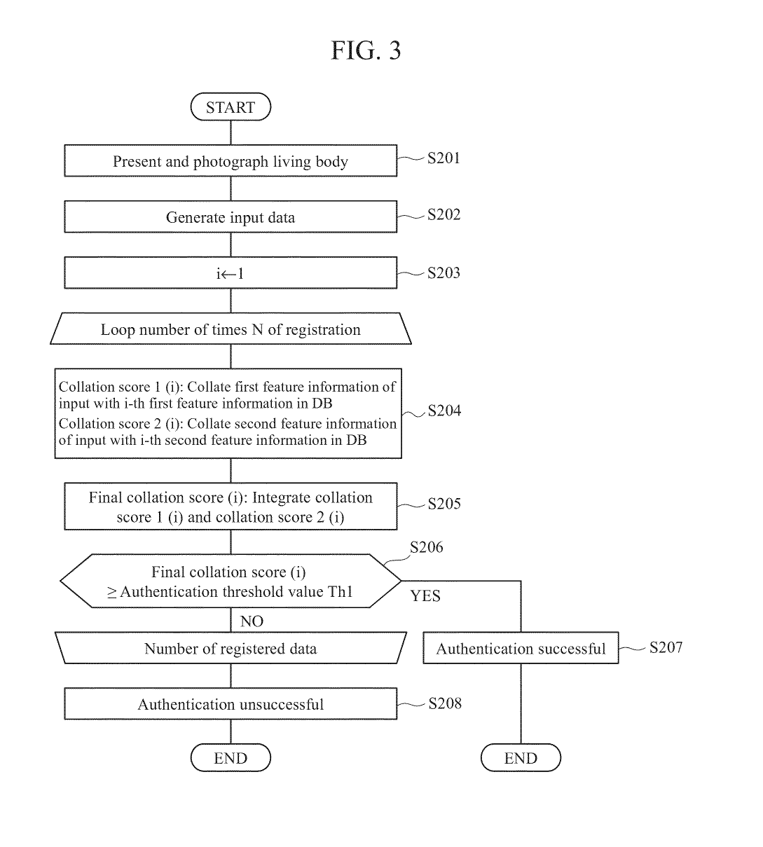

FIG. 3 is an exemplary flowchart of authentication utilizing the first biometric feature information 6-1 and the second biometric feature information 6-2 in the present embodiment. In the following, the first biometric feature information 6-1 and the second biometric feature information 6-2 will be respectively referred to as the first feature information 6-1 and the second feature information 6-2.

When authentication is performed for person p1, after person p1 presents a living body of the person to the measurement device 12, such as a camera, the measurement device 12 senses the living body of person p1 (S201). When the first feature information 6-1 and the second feature information 6-2 are of the same biometric modality, measurement may be made once. When the first feature information 6-1 and the second feature information 6-2 are of different biometric modalities, a plurality of measurements may be required.

Then, the image input unit 18 generates, on the basis of the information measured by the measurement device 12, the first feature information 6-1 and the second feature information 6-2 as input data (S202). As will be described later, the second feature information 6-2 may be partial information of the first feature information. In this case, where the first feature information 6-1 and the second feature information 6-2 are obtained from one biometric modality information item, the image input unit 18 may input one piece of feature information (such as the first feature information) as the input data.

Then, the authentication unit 101 initializes a variable i identifying the registered data to 1 for collation process initialization (S203). The variable i corresponds to the order of arrangement of the registered data. When i is 1, the initial registered data is indicated; when the number of the registered data items is N, the last registered data is indicated. The authentication unit 101 collates the first feature information 6-1, which is the generated input data, with the first feature information 6-1, which is the i-th registered data on the registration databases 8, to calculate a collation score 1 (i). The authentication unit 101 further collates the second feature information 6-2 as the input data with the second feature information 6-2 as the i-th registered data on the registration databases 8, to calculate a collation score 2 (i) (S204).

The authentication unit 101 then calculates a final collation score (i) for making a final authentication determination by integrating the collation score 1 (i) and the collation score 2 (i) (S205). The authentication unit 101 determines whether the final collation score (i) is equal to or greater than an authentication threshold value Th1 which is previously set (S206). If the determination condition is satisfied, the authentication unit 101 determines that authentication is successful (S207).

If the final collation score (i) is below the authentication threshold value Th1, the authentication unit 101 increments the value of the variable i, and performs collation with the next registered data in the registration databases 8. As a result of collation with the last registered data N, if the final score (N) is below the authentication threshold value, the authentication unit 101 determines that authentication is unsuccessful because there is no registered data to be collated (S208).

In the present embodiment, the collation score 1 (i), which is the result of collation between two items of the first feature information 6-1, has only a single value. However, there is a plurality of items of the second feature information 6-2 as the i-th registered data. Thus, a plurality of collation scores 2(i) is calculated as the result of collation between the second feature information 6-2 items. Accordingly, the collation score 2 (i) provides vector data including a plurality of values. The final collation score (i) may be calculated by a method of linear combination of a plurality of scores including the collation score 1 (i) and the collation score 2 (i), or by an integrating method based on the probability density function of each of the collation scores utilizing Bayesian statistics.

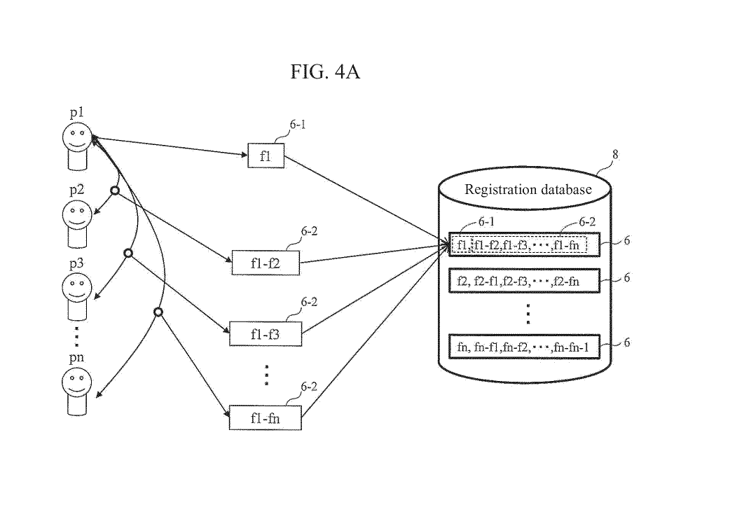

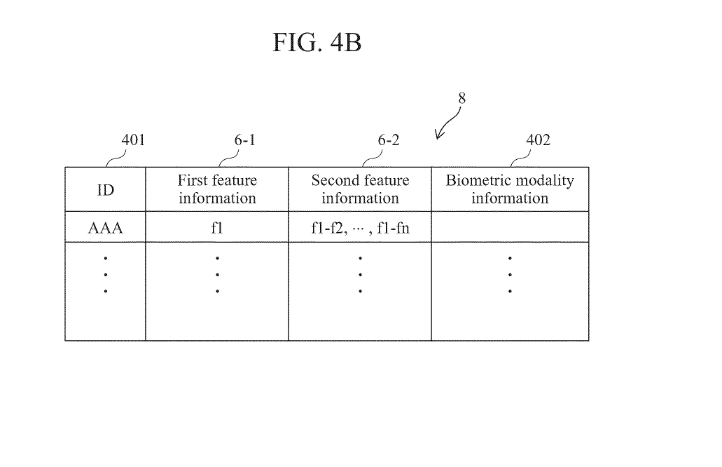

A method of registering the first feature information 6-1 and the second feature information 6-2 in the registration databases 8 will be described. FIG. 4A illustrates extraction of a biometric feature of person p1 and registration of the biometric feature.

Herein, on the assumption that the measurement device 12 has produced one or more items of biometric modality information with respect to each of persons p1 to pn, a process of extraction and registration of the first feature information 6-1 and the second feature information 6-2 of person p1 will be described. As described above, the first feature information 6-1 and the second feature information 6-2 may be extracted from the same biometric modality or from different biometric modalities.

The first feature information 6-1(f1) extracted from the biometric modality information of person p1 is extracted independently without consideration of its relationships with the living bodies of persons other than p1 (p2, . . . , pn). The registration unit 102 extracts the first feature information 6-1(f1) from the biometric modality information of person p1. The registration unit 102 registers the extracted first feature information 6-1(f1) in the registration database 8.

Meanwhile, the second feature information 6-2 is a feature having high correlation value between person p1 and persons other than person p1 (p2, . . . , pn). The registration unit 102 compares the biometric modality information of person p1 with the biometric modality information of certain others (p2, . . . , pn), and extracts, from the biometric modality information of person p1, a feature having high correlation value (similarity) with respect to each of the others as the second feature information 6-2. The registration unit 102 registers the extracted second feature information 6-2 (f1-f2, . . . , f1-fn) in the registration database 8.

As illustrated in FIG. 4A, because there is a plurality of persons other than p1(p2, . . . , pn), the second feature information 6-2 is extracted in a distinguished manner for each combination of persons. For example, the registration unit 102 initially extracts a feature with high correlation between the biometric modality information of person p1 and the biometric modality information of person p2 as the second feature information 6-2 (f1-f2). Then, the registration unit 102 extracts a feature with high correlation between the biometric modality information of person p1 and the biometric modality information of person p3 as the second feature information 6-2 (f1-f3). Similarly, the process is repeated until person pn.

Thus, when items of the second feature information 6-2 are extracted, the second feature information 6-2 (f1-fi) having high correlation value varies for each combination of person p1 and person pi (2≦i≦n). Namely, depending on the combination of person p1 and person pi, the biometric location, position, size and the like from which the second feature information 6-2 (f1-fi) is extracted may vary. The second feature information 6-2 (f1-fi) has high correlation value (similarity) only between person p1 and the specific person pi. Thus, the similarity obtained by collation of the second feature information 6-2 (f1-fi) of person p1 with the second feature information 6-2 (f3-fi) of a person other than person p1 (such as person p3) is low. In the example of FIG. 4A, the second feature information 6-2 (f1-fi) is extracted with respect to all persons other than p1 (p2, . . . , pn); however, this is not a limitation. The second feature information 6-2 may be extracted with respect to at least one person other than p1.

Meanwhile, in the example of FIG. 4A, the second feature information 6-2 (f1-f2) of person p1 that is extracted from the relationship between the biometric modality information of person p1 and the biometric modality information of person p2 is information having high correlation value between persons p1 and p2. Namely, the second feature information 6-2 (f1-f2) of person p1 and the second feature information 6-2 (f2-f1) of person p2 are similar. Thus, when the second feature information 6-2 (f1-f2) of person p1 is registered, the second feature information 6-2 (f1-f2) extracted from the biometric modality information of person p1 may be registered, or the second feature information 6-2 (f2-f1) extracted from the biometric modality information of person p2 may be registered. In another example, the second feature information 6-2 (f1-f2) extracted from the biometric modality information of person p1 and the second feature information 6-2 (f2-f1) extracted from the biometric modality information of person p2 may be averaged, and the resultant information may be registered.

FIG. 4B illustrates an example of the registration database 8. While the figure shows a table structure for description, the data structure is not limited to a table and other data structures may be used.

The registration database 8 is provided with a first table including an identifier (ID) 401 for identifying each person, the first feature information 6-1, the second feature information 6-2, and biometric modality information 402. As in the illustrated example, the biometric modality information of each person may be registered in the registration database 8 together with the first feature information 6-1 and the second feature information 6-2. For example, when a person pz is newly registered in the registration database 8, the registration unit 102 may extract the first feature information 6-1 and the second feature information 6-2 by comparing the biometric modality of person pz with the biometric modality information of each person in the registration database 8, and then register the extracted information in the registration database 8.

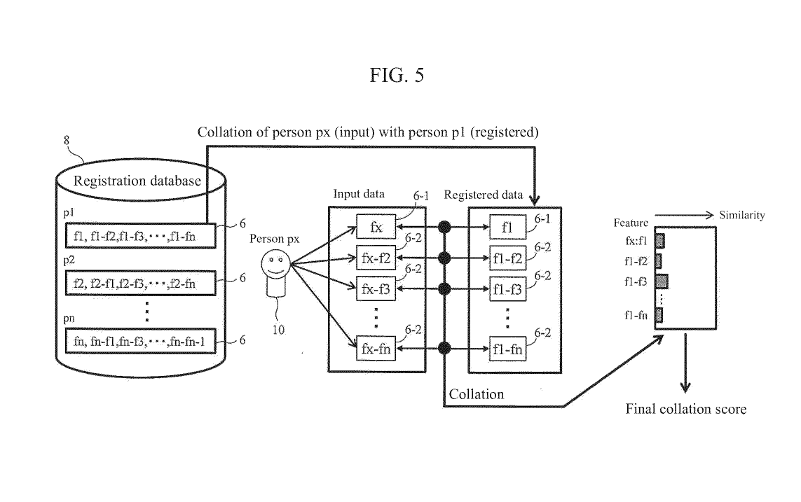

FIG. 5 illustrates an example of collation of the registered data registered in the registration database 8 with the input data of an authentication-requesting person. Initially, when person px for authentication is collated with the registered data of person p1, the first feature information 6-1(fx) is extracted from a living body presented by person px. Thereafter, the authentication unit 101 collates the first feature information 6-1(fx) with the first feature information 6-1(f1) of the registered person p1 so as to calculate similarity. Then, the authentication unit 101 collates a plurality of items of the second feature information 6-2 (f1-f2, f1-f3, . . . , f1-fn) of the registered person p1 with a plurality of items of the second feature information 6-2 (fx-f2, fx-f3, . . . , fx-fn) extracted from the living body of person px. Specifically, a plurality of similarities is calculated by collating the respectively corresponding second feature information 6-2 items. Then, the authentication unit 101 calculates a final collation score from the obtained plurality of similarities. When the final collation score exceeds a preset threshold value, the authentication unit 101 determines person px as being person p1. On the other hand, when the final collation score is below the threshold value, person px is determined to be not person p1.

In the present example, when the arbitrary authentication-requesting person px that is input is authenticated using the second feature information 6-2 registered in the registration database 8, the image input unit 18 does not know which information is to be extracted from the biometric modality information of the authentication-requesting person px as the second feature information 6-2 (fx-f2, fx-f3, . . . , fx-fn). Thus, the authentication unit 101 needs to search a range of the biometric modality information in which the second feature information is present while collating a position similar to the registered second feature information 6-2 (f1-f2, f1-f3, . . . , f1-fn).

Herein, a case will be considered in which collation is performed with the second feature information 6-2 (f1-f2) of person p1 registered in the registration database 8. Specifically, when it is authenticated as to whether the authentication-requesting person px is person p1, it is necessary to collate the biometric modality information of the authentication-requesting person px with the second feature information 6-2 (f1-f2) to calculate similarity. However, because it is not known whether the authentication-requesting person px is person p1, it is not known in fact which information in the biometric modality information of the authentication-requesting person px is the second feature information 6-2 (fx-f2) that should be the object of collation with the second feature information 6-2 (f1-f2). Thus, in the present embodiment, the biometric modality information of the authentication-requesting person px is searched for feature information exhibiting high similarity to the registered second feature information 6-2 (f1-f2), and the feature information obtained as a result of the search is handled as the second feature information 6-2 (fx-f2). For example, the authentication unit 101 handles the feature information, among the biometric modality information of the authentication-requesting person px, exhibiting the highest similarity to the registered second feature information 6-2 (f1-f2) as the second feature information 6-2 (fx-f2). The authentication unit 101 determines that the highest similarity is the similarity f1-f2 as the result of collation of the second feature information 6-2 (fx-f2) of the authentication-requesting person px with the registered second feature information 6-2 (f1-f2).

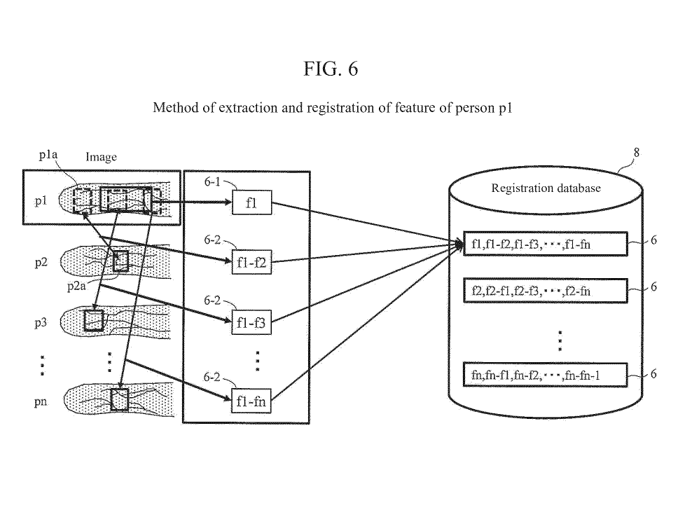

A more specific embodiment will be described. In the following, human biometric modality information is provided by finger blood vessel images, and the first feature information 6-1 and the second feature information 6-2 are provided by finger blood vessel patterns extracted from the finger blood vessel images. FIG. 6 illustrates an example of extraction of the first feature information 6-1 and the second feature information 6-2 from the finger blood vessel images, and registration of the information in the registration database 8.

As illustrated in FIG. 6, by the measurement device 12 (specifically, a camera), blood vessel images of person p1, person p2, . . . , and person pn have been obtained. First, the registration unit 102 extracts the first feature information 6-1(f1) from the finger blood vessel image of person p1. The registration unit 102 extracts the first feature information 6-1(f1) from the finger blood vessel image of person p1 by a uniform method, without considering the relationship with the images of the persons other than person p1. As illustrated in FIG. 6, the first feature information 6-1(f1) may be extracted from a predetermined region of the finger blood vessel image.

Then, the registration unit 102 extracts, as the second feature information 6-2, partial patterns having high similarity between the finger blood vessel image of person p1 and the finger blood vessel images of the others (p2, . . . , pn). For example, the registration unit 102 searches for a certain partial pattern of the finger blood vessel image of person p1 by matching in the entire region of the finger blood vessel image of person p2, and detects the partial pattern having high similarity to the finger blood vessel image of person p2. The registration unit 102 determines the detected partial pattern as being the second feature information 6-2 (f1-f2). Similarly, the registration unit 102 detects a partial pattern having high similarity between the finger blood vessel image of person p1 and the finger blood vessel image of each of the others (p3, . . . , pn). The registration unit 102 determines that the detected partial patterns are the second feature information 6-2 (f1-f3), . . . , (f1-fn), respectively. The first feature information 6-1(f1) thus extracted and a plurality of items of the second feature information 6-2 (f1-f2, f1-f3, . . . , f1-fn) provide the feature of person p1.

In the example of FIG. 6, a blood vessel partial pattern p1a of person p1 and a blood vessel partial pattern p2a of person p2 are similar. Thus, the second feature information 6-2 (f1-f2) of person p1 may be provided by the partial pattern p1a, which is a part of the blood vessels of person p1. Alternatively, the second feature information 6-2 (f1-f2) may be provided by the partial pattern p2a, which is a part of the blood vessel pattern of person p2.

In another example, with respect to the blood vessel partial patterns p1a and p2a having high similarity, a pattern during a deformation process, such as morphing in which one partial pattern is brought closer to another partial pattern, may be extracted as the second feature information 6-2 (f1-f2).

In the example of FIG. 6, the second feature information 6-2 (f1-f2) extracted as the blood vessel partial pattern having high similarity between person p1 and person p2, and the second feature information 6-2 (f1-f3) extracted as the blood vessel partial pattern having high similarity between person p1 and person p3 have different sizes of the blood vessel partial pattern regions. Namely, depending on the combination of the persons, the second feature information 6-2 as a blood vessel partial pattern having high similarity may be extracted in various region sizes. The greater the region size of the second feature information 6-2, the higher the identifiability of the feature becomes.

As a method of detecting the blood vessel partial pattern as the second feature information 6-2, the following examples may also be applied. For example, initially, each of the finger blood vessel images of two persons is divided by a preset number into a plurality of partial patterns. Then, a combination of the partial patterns with the highest similarity is selected from a plurality of combinations of the partial patterns, and the selected partial patterns may provide the second feature information 6-2. In another example, the partial pattern having high similarity may be detected by varying the region size or position from which the partial pattern is cut out in each of the finger blood vessel images of two persons.

It is also possible to obtain the second feature information 6-2 by extracting a partial pattern from a partial region of high similarity calculated by collation that utilizes local features, such as collation of feature points in the finger blood vessel image. In this case, for example, a threshold value concerning the similarity calculated by collation of two blood vessel partial patterns is set in advance. When the similarity of the two blood vessel partial patterns exceeds the threshold value, the partial patterns may provide the second feature information 6-2. When a plurality of partial patterns having high similarity between the two finger blood vessel images is detected, each partial pattern may provide the second feature information 6-2.

While in the present embodiment the second feature information 6-2 is provided by a blood vessel partial pattern, other information may be used as the second feature information 6-2. For example, as the second feature information 6-2, there may be adopted information such as the number of blood vessels included in a blood vessel partial pattern, the ratio of blood vessels in a partial pattern region, or the direction of flow of blood vessels in the partial pattern.

In another example, the second feature information 6-2 may be provided by a histogram, such as information about the brightness gradient of a blood vessel image in a partial pattern. In this case, information which is robust with respect to an error in the position for cutting out the blood vessel partial pattern can be used as the second feature information 6-2, whereby authentication accuracy can be improved. It goes without saying that the second feature information 6-2 may be provided by other features that can be extracted from the blood vessel image.

A method of registering the first feature information 6-1 and the second feature information 6-2 that have been extracted will be described. As illustrated in FIG. 6, the registration unit 102 registers the first feature information 6-1(f1) and a plurality of items of the second feature information 6-2 (f1-f2, f1-f3, . . . , f1-fn) that have been extracted in the registration database 8 as the feature of person p1.

With regard to the order in which the plurality of items of the second feature information 6-2 (f1-f2, f1-f3, . . . , f1-fn) is stored for registration, the second feature information 6-2 with greater region size may be stored earlier, for example. In this way, it becomes possible to perform collation with the blood vessel image of the authentication-requesting person from the second feature information 6-2 of greater size and higher identifiability. In another example, the second feature information 6-2 may be stored in the order of decreasing level of identifiability on the basis of an index representing the level of identifiability of the second feature information 6-2. When registered data is newly added to the registration database 8, not only are the first feature information 6-1 and the second feature information 6-2 of the newly registered person pn+1 registered, but also the second feature information 6-2 of the persons p1 to pn that are already registered are updated. For example, with respect to the registered person p1, the second feature information 6-2 (f1-fn+1) is extracted between person p1 and the newly registered person pn+1 and added as registered data for person p1.

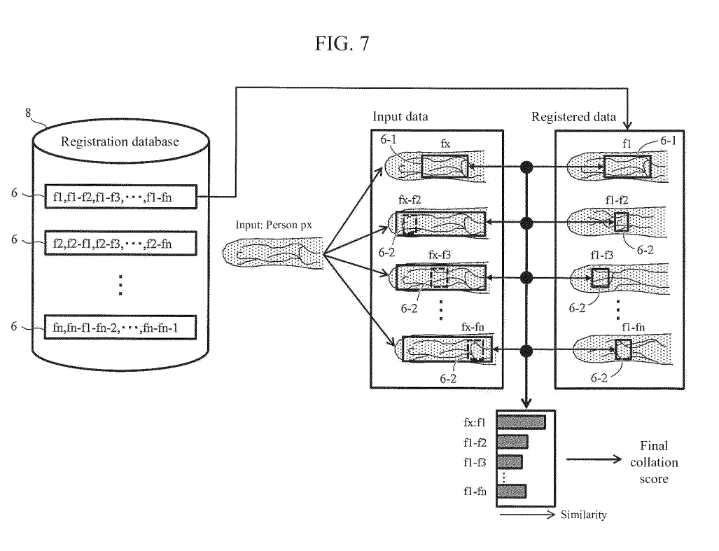

While the flow of the authentication process is the same as the flowchart of FIG. 3, a specific flow of the authentication process will be described with reference to a case in which person px is authenticated. FIG. 7 illustrates collation of the biometric features of the authentication-requesting person px and the registered person p1.

First, the authentication-requesting person px presents a living body of the person, and a finger blood vessel image is acquired by the measurement device 12. The image input unit 18 extracts from the acquired finger blood vessel image a blood vessel pattern providing the first feature information 6-1(fx), and inputs the pattern to the authentication processing unit 13. The authentication unit 101 collates the first feature information 6-1(fx) of the authentication-requesting person px with the first feature information 6-1(f1) of the registered person p1 to calculate similarity.

With regard to the collation of the second feature information 6-2, the authentication unit 101 calculates similarity by searching the finger blood vessel image of the authentication-requesting person px for the second feature information 6-2 of the registered person p1. For example, as illustrated in FIG. 7, the authentication unit 101 searches the entire finger blood vessel image of the authentication-requesting person px for the second feature information 6-2 (f1-f2) of the registered person p1. As a result of the search, as illustrated in FIG. 7, the similarity becomes maximum at the position of a partial pattern in a broken-line frame in the entire finger blood vessel image. The authentication unit 101 determines the maximum-similarity partial pattern as being the second feature information 6-2 (fx-f2), and records the similarity as the similarity between the second feature information 6-2 (fx-f2) and the second feature information 6-2 (f1-f2) of person p1. Likewise, the authentication unit 101 searches the entire finger blood vessel image of the authentication-requesting person px for the second feature information 6-2 (f1-fi) of person pi, and records the similarity at the position of the highest similarity. The authentication unit 101 integrates a plurality of similarities thus obtained, and calculates a final collation score. If the final collation score exceeds a preset authentication threshold value, px is authenticated as p1; if below the threshold value, px is collated with the next registered data on the registration database 8.

In the present example, it is necessary to collate the registered second feature information 6-2 (f1-f2) of person p1 with the second feature information 6-2 (f1-f2) of the authentication-requesting person px to calculate similarity. However, it is not known which partial pattern in the finger blood vessel image of the authentication-requesting person px should be the second feature information 6-2 (fx-f2) as the object of collation with the second feature information 6-2 (f1-f2). Thus, as illustrated in FIG. 7, the entire finger blood vessel image region of the authentication-requesting person px is searched for the position (partial pattern) where the similarity to the second feature information 6-2 (f1-f2) of person p1 becomes maximum by collation, whereby the similarity between the partial pattern in the finger blood vessel image of the authentication-requesting person px and the second feature information 6-2 (f1-f2) of person p1 can be calculated.

In the above configuration, feature information beneficial for authentication that has not been used is drawn out of biometric modality information, whereby authentication can be performed fully taking advantage of the feature information. Particularly, the biometric feature information 6 includes the first feature information 6-1 extracted by only referring to the biometric modality information of one person, and the second feature information 6-2 acquired based on the correlation between the biometric modality information items of different persons. By utilizing the second feature information 6-2 in addition to the first feature information 6-1, highly accurate authentication can be performed.

### Second Embodiment

In the present embodiment, a configuration in which the second feature information 6-2 is extracted from the biometric modality information of the authentication-requesting person will be described. In the present embodiment, an extraction property is registered in the registration database 8 along with the second feature information 6-2. The extraction property herein refers to attribute information for extracting, from the input information, the second feature information 6-2 as the object of collation with the second feature information 6-2 in the registration database 8. For example, the extraction property includes information about biometric location, extraction position, or region size and the like.

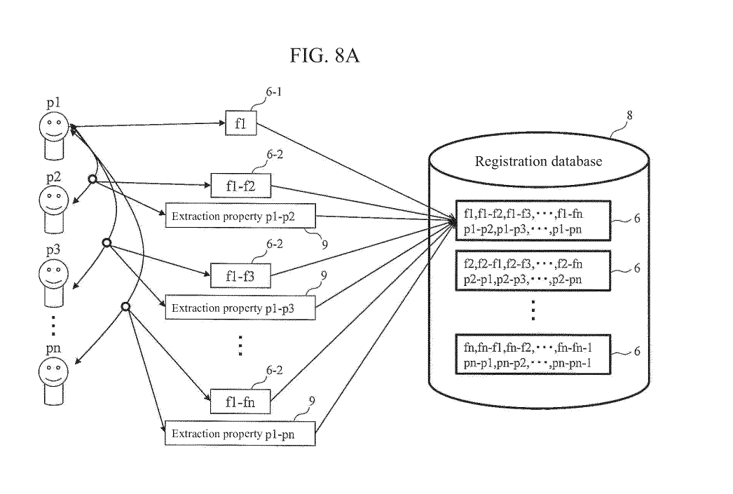

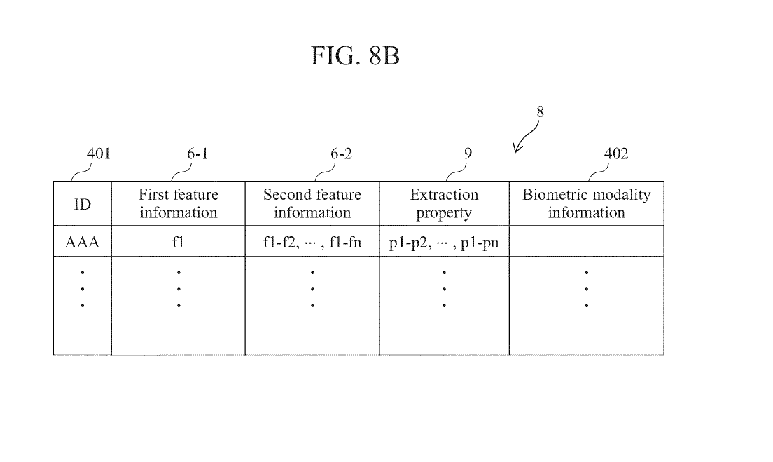

FIG. 8A illustrates a configuration for registering the extraction property for the second feature information 6-2 along with the second feature information 6-2. The first feature information 6-1(f1) extracted from the biometric modality information of person p1 is extracted independently without considering the relationship with the living body of persons other than p1(p2, . . . , pn). The registration unit 102 extracts the first feature information 6-1(f1) from the biometric modality information of person p1.

On the other hand, the second feature information 6-2 is a feature having high correlation value between person p1 and persons (p2, . . . , pn) other than person p1. The registration unit 102 compares the biometric modality information of person p1 with the biometric modality information of certain others (p2, . . . , pn), and extracts, from the biometric modality information of person p1 and as the second feature information 6-2, a feature having high correlation value (similarity) with each of the others. At this time, the registration unit 102 also acquires, for each combination of person p1 and the others, information about extraction property 9 representing attribute information of the second feature information 6-2. The registration unit 102 registers the extraction property 9 of the second feature information 6-2 in the registration database 8 along with the second feature information 6-2.

Depending on the combination of person p1 and each of the others pi, the extraction property 9 (p1-pi) representing the attribute information, such as the biometric location, extraction position, or region size, for extracting the second feature information 6-2 (f1-fi) may vary. Thus, the registration unit 102 registers the extraction property (p1-pi) of the second feature information 6-2 (f1-fi) in the registration database 8 for each combination of person p1 and each of the others pi. FIG. 8B illustrates an example of a table of the registration database 8 according to the present embodiment. For example, the configuration of FIG. 4B may be provided with the additional item for storing the information of the extraction property 9.

The extraction property 9 may include, in addition to the above-described examples, a correlation value (similarity) between the second feature information 6-2 (f1-fi) of person p1 at the time of registration and the second feature information 6-2 (fi-f1) of person pi. Thus, as the extraction property 9, there may be registered a correlation value such as an average or dispersion of similarities in the collation of the second feature information 6-2 (f1-fi) of the registered person p1 with the second feature information 6-2 (fi-f1) of person pi. In this way, the authenticity of the subject person can be determined with increased accuracy on the basis of a difference between the registered correlation value and the correlation value calculated using the second feature information 6-2 (f1-fi) at the time of actual authentication.

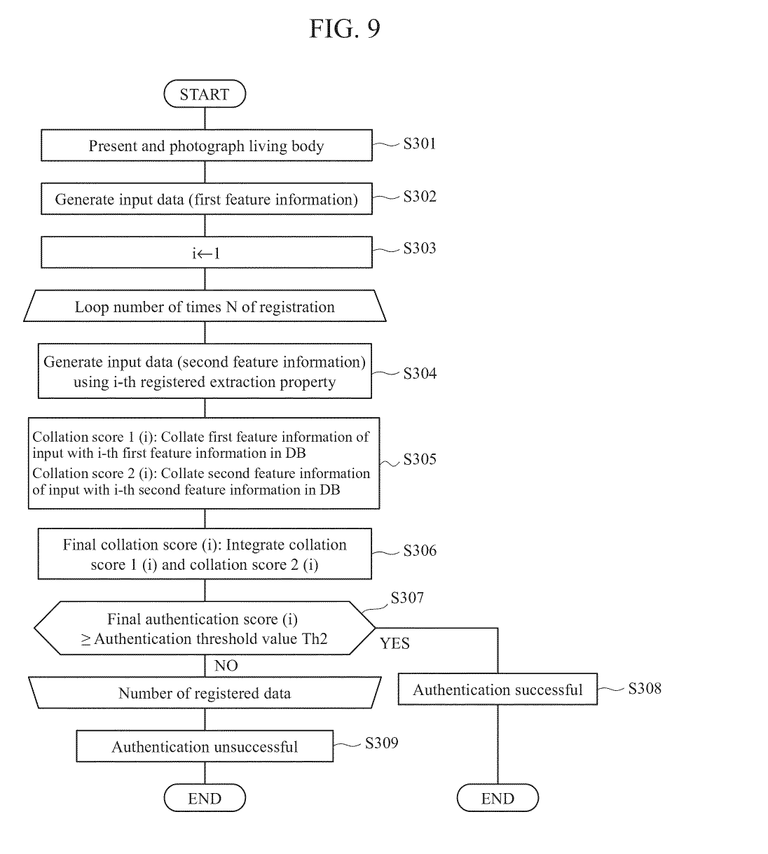

FIG. 9 shows an example of a flowchart for authentication using the extraction property 9 of the second feature information 6-2. The authentication-requesting person presents the living body to the measurement device 12 such as a camera, and then the measurement device 12 senses the living body of the authentication-requesting person (S301). Then, the image input unit 18 generates the first feature information 6-1 as input data on the basis of biometric modality information measured by the measurement device 12 (S302).

The authentication unit 101 then initializes the variable i identifying the registered data to 1 for collation process initialization (S303). The variable i corresponds to the order of arrangement of registered data. When i is 1, the initial registered data is indicated; when the number of registered data items is N, the last registered data is indicated. The image input unit 18 generates, from the biometric modality information of the authentication-requesting person and by utilizing the extraction property 9 of the i-th registered second feature information 6-2, the second feature information 6-2 as the input data (S304).

The authentication unit 101 then collates the first feature information 6-1, i.e., the generated input data, with the first feature information 6-1 that is the i-th registered data on the registration database 8, and calculates a collation score 1 (i). Further, the authentication unit 101 collates the second feature information 6-2 as input data with the second feature information 6-2 as the i-th registered data on the registration database 8, and calculates a collation score 2 (i) (S305).

Then, the authentication unit 101 integrates the collation score 1 (i) and the collation score 2 (i) to calculate a final collation score (i) for final authentication determination (S306). The authentication unit 101 determines whether the final collation score (i) is equal to or greater than an authentication threshold value Th2 that is set in advance (S307). If this determination condition is satisfied, the authentication unit 101 determines that the authentication is successful (S308).

If the final collation score (i) is below the authentication threshold value Th2, the authentication unit 101 increments the value of the variable i, and performs collation with the next registered data on the registration database 8. As a result of the collation with the last registered data N, if the final score (N) is below the authentication threshold value, the authentication unit 101 determines that the authentication is unsuccessful because of the absence of registered data to be collated (S309).

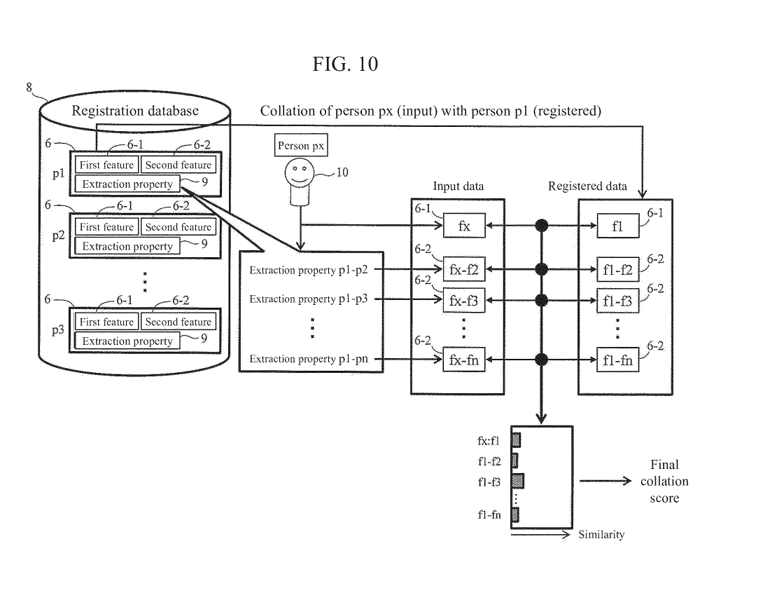

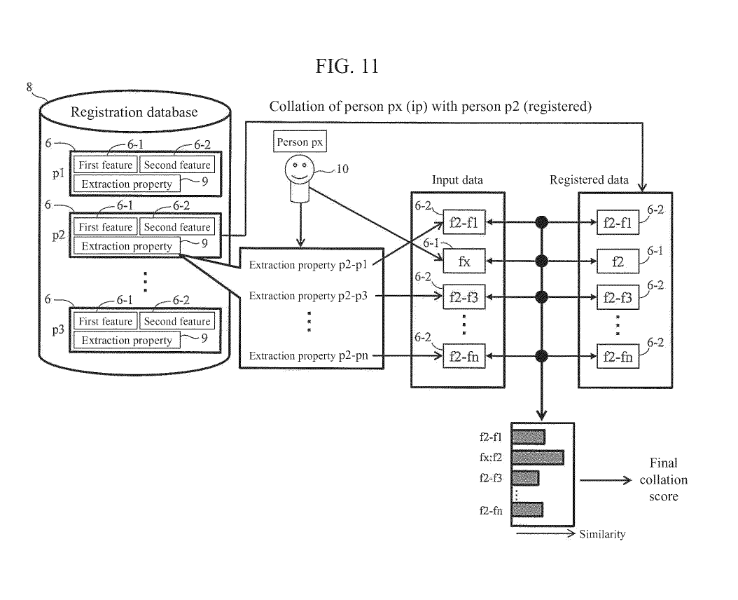

FIG. 10 and FIG. 11 show diagrams for describing an authentication method in a case where the first feature information 6-1, the second feature information 6-2, and the extraction property 9 are registered together.

When person px is authenticated with the registered data of persons on the registration database 8, the first feature information 6-1 and the second feature information 6-2 of person px are extracted. The authentication unit 101 authenticates person px on the basis of the level of similarity calculated by collation with the first feature information 6-1 and the second feature information 6-2 of the persons on the registration database 8. The operation of the authentication is similar to FIG. 5 with the exception that, when the second feature information 6-2 is extracted from person px, the extraction property 9 registered in the registration databases 8 is utilized.

When the authentication-requesting person px and person p1 on the registration database 8 are collated, the first feature information 6-1(fx) is extracted from the biometric modality information of person px. The authentication unit 101 calculates similarity by collating the first feature information 6-1(fx) with the first feature information 6-1(f1) of the registered person p1. When the second feature information 6-2 (fx-fi) is extracted from the authentication-requesting person px for collation with person p1, the extraction property 9 (p1-p2, . . . p1-pn) on the registration database 8 is utilized. By utilizing the extraction property 9 (p1-p2, . . . p1-pn), a plurality of items of the second feature information 6-2 (fx-f2, fx-f3, . . . fx-fn) is extracted from the biometric modality information of person px. The authentication unit 101 collates the second feature information 6-2 (fx-2, fx-f3, . . . fx-fn) of the authentication-requesting person px respectively with the second feature information 6-2 (f1-f2, f1-f3, . . . f1-fn) of person p1 so as to calculate similarity. Then, the authentication unit 101 calculates the final collation score from the obtained plurality of similarities. If the final collation score is greater than the preset threshold value, the authentication unit 101 determines that person px is person p1. In the example of FIG. 10, because the values of the plurality of similarities are generally low and the final collation score is also low, the authentication-requesting person px is determined to be not person p1. On the other hand, in the example of FIG. 11, the values of the plurality of similarities are generally high and the final collation score is also high, so that the authentication-requesting person px is determined to be person p2.

In the above example, the second feature information 6-2 is extracted as a feature having high correlation between the living bodies of two persons. However, a feature having high correlation between three or more persons may be extracted as third feature information. Generally, the greater the number of persons, the less likely it becomes for a feature having high correlation between a plurality of persons to appear, making the identifiability of the feature higher.

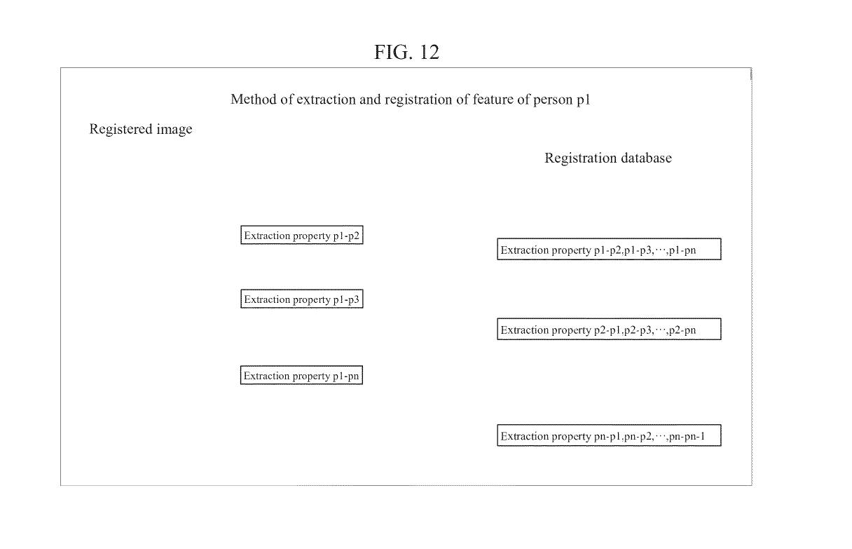

A more specific embodiment will be described. In the following, the human biometric modality information is provided by finger blood vessel images, and the first feature information 6-1 and the second feature information 6-2 that are extracted are provided by finger blood vessel patterns extracted from the finger blood vessel images. FIG. 12 illustrates an example in which the first feature information 6-1, the second feature information 6-2, and the extraction property 9 are extracted from the finger blood vessel images and registered in the registration database 8.

As illustrated in FIG. 12, blood vessel images of person p1, person p2, . . . , and person pn are obtained by the measurement device 12 (specifically, a camera). First, the registration unit 102 extracts the first feature information 6-1(f1) from the finger blood vessel image of person p1. The registration unit 102 extracts the first feature information 6-1(f1) from the finger blood vessel image of person p1 by a uniform method without considering the relationship with the images of the persons other than person p1. The registration unit 102 then extracts, as the second feature information 6-2, a partial pattern having high similarity between the finger blood vessel image of person p1 and the finger blood vessel images of the others (p2, . . . , pn). For example, the registration unit 102 searches the entire region of the finger blood vessel image of person p2 for a certain partial pattern of the finger blood vessel image of person p1 by matching, and detects a partial pattern having high similarity to the finger blood vessel image of person p2. At this time, the registration unit 102 also acquires information about the extraction property 9, such as the position at which the partial pattern providing the second feature information 6-2 is extracted, or a region size. The registration unit 102, when registering the blood vessel partial pattern of the second feature information 6-2, also registers the extraction property corresponding to the second feature information 6-2 in the registration database 8.

In this configuration, when the blood vessel partial pattern of the second feature information 6-2 is registered, the extraction property (such as position or region size) for extracting the second feature information 6-2 from the entire finger blood vessel image is also registered. In this way, when the authentication-requesting person is authenticated, it becomes possible to uniquely extract, from the finger blood vessel image of the arbitrary authentication-requesting person px and by utilizing the extraction property, the blood vessel partial pattern providing the second feature information 6-2, and to collate the partial pattern with the second feature information of each of the persons in the registration database 8.

As illustrated in FIG. 12, depending on the combination of person p1 and person pi, the extraction property 9 (p1-pi) representing the attribute information, such as the position or a region size at which the partial pattern as the second feature information 6-2 (f1-fi) is extracted from the finger blood vessel image may vary. Thus, the extraction property (p1-pi) of the second feature information 6-2 (f1-fi) is registered in the registration database 8 for each combination of persons p1 and pi.

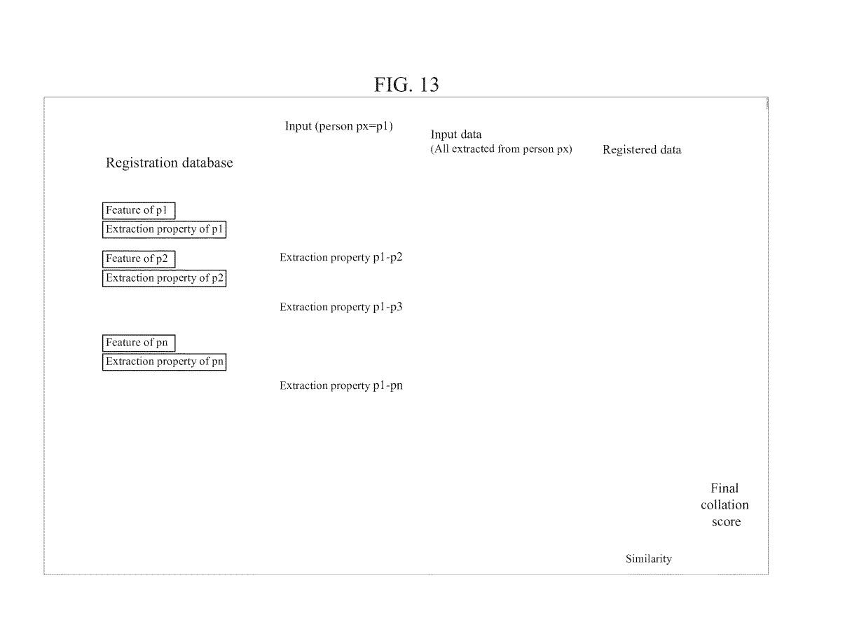

FIG. 13 shows a diagram for describing an example of authentication using the extraction property as attribute information. In the example of FIG. 13, the authentication-requesting person px and the registered data of person p1 are collated.

First, the authentication-requesting person px presents a living body, and a finger blood vessel image is acquired by the measurement device 12. The image input unit 18 extracts from the acquired finger blood vessel image a blood vessel pattern that provides the first feature information 6-1(fx). With regard to the second feature information 6-2, the image input unit 18 extracts, from the finger blood vessel image of the authentication-requesting person px and by utilizing the extraction property 9 registered in the registration database 8, the second feature information 6-2 (fx-f2). Similarly, the image input unit 18 extracts, from the finger blood vessel image of the authentication-requesting person px and by utilizing the extraction property 9 registered in the registration database 8, the second feature information 6-2 (fx-f3, . . . , fx-fn).

Then, the authentication unit 101 calculates similarity by collating the first feature information 6-1(fx) of the authentication-requesting person px with the first feature information 6-1(f1) of person p1. Further, the authentication unit 101 collates each item of the second feature information 6-2 (fx-f2, . . . , fx-fn) of the authentication-requesting person px with the corresponding second feature information 6-2 (f1-f2, . . . , f1-fn) of person p1 to calculate similarity. The authentication unit 101 integrates a plurality of similarities thus obtained, and calculates a final collation score. If the magnitude of the final collation score is greater than the preset authentication threshold value, px is authenticated as p1; if below the threshold value, px is collated with the next registered data on the registration database 8.

In the present embodiment, the extraction property, such as the position of extraction or size of the second feature information 6-2 as a partial pattern in the blood vessel image in each combination of various persons, is registered in the registration database 8. Thus, by utilizing the extraction property, the second feature information 6-2 can be uniquely extracted from the blood vessel image of the subject px that has been input.

In the present embodiment, the second feature information 6-2 is extracted as a similar partial pattern between any and all two finger blood vessel images (blood vessel patterns). However, in reality, a similar partial pattern may not necessarily exist between two finger blood vessel images. Thus, when a similar partial pattern does not exist, one blood vessel pattern may be subjected to at least one of pattern transformation processes of rotation, inversion, size change (scale change), or deformation. In this way, a similar partial pattern between two finger blood vessel images can be extracted.

For example, it is assumed that a similar blood vessel partial pattern could not be found between person p1 and person p2 when the second feature information 6-2 of person p1 is registered. In this case, the registration unit 102 subjects the blood vessel partial pattern of person p2 to the above pattern transformation process so as to generate a partial pattern similar to the blood vessel partial pattern of person p1. The registration unit 102 may register the pattern obtained through transformation of the blood vessel partial pattern of person p2 as the second feature information 6-2 (f1-f2). If person p1 is the authentication-requesting person, a partial pattern (input data) as the second feature information 6-2 extracted from person p1 may be collated with the second feature information 6-2 (registered data) generated through transformation of the partial pattern of person p2, whereby high similarity can be obtained.

If there are not many blood vessel patterns of person p1 as the authentication-requesting person, and if the blood vessel patterns do not include many geometric structures, such as curves, the authentication unit 101 may subject the blood vessel partial pattern of person p1 to the transformation process. In this way, it can be expected that authentication accuracy will be increased. As the extraction property 9 of the second feature information 6-2, in addition to the position of extraction or size of the second feature information 6-2, parameter information of the partial pattern transformation process may also be registered in the registration database 8. In this way, by utilizing the pattern transformation process parameter at the time of authentication, the authentication unit 101 can subject the blood vessel partial pattern of person p1 as the authentication-requesting person to pattern transformation process.

With regard to the handling of a plurality of similarities, in the present embodiment, similarity obtained by collation with the first feature information 6-1 and similarity obtained by collation with the second feature information 6-2 are calculated. In the foregoing examples, the plurality of similarities are integrated to determine a single similarity (final collation score) for authentication. In another example, collation may be performed using the first feature information 6-1 first. If the similarity is higher than a preset authentication threshold value, it may be determined that authentication has been successful, and only if the similarity is lower than the authentication threshold value, a plurality of similarities based on the collation of the second feature information 6-2 may be utilized. Conversely, collation may be performed first with the second feature information 6-2. If the similarity is higher than the preset authentication threshold value, it may be determined that the authentication has been successful, and only if the similarity is lower than the authentication threshold value, the similarity based on the collation of the first feature information 6-1 may be utilized. Alternatively, an authentication result may be determined on the basis of the similarity based on the collation of only the second feature information 6-2.

With regard to the order of collation with the second feature information 6-2, when the number of registered data items of the second feature information 6-2 in the registration database 8 is small, collation may be performed with all of the registered second feature information 6-2 items for authentication. However, when the number of registered data items of the second feature information 6-2 is very large, it may take much time for collation with all of the registered second feature information 6-2 items. In this case, collation may be performed only with those of the plurality of items of the registered second feature information 6-2 that have a large degree of contribution to the authentication result. In this way, the difference between the result of determination of authentication in a case where collation is terminated before performing collation with all of the second feature information 6-2 items, and the result of determination of authentication in a case where collation is performed with all of the second feature information 6-2 items may be virtually eliminated. In addition, the speed of the authentication process can be increased.

As to the method of calculating the degree of contribution to the authentication result, the level of similarity of the biometric features of two persons at the time of registration of the second feature information 6-2 may be considered the degree of contribution. Alternatively, the level of the so-called identifiability of the second feature information 6-2 may be considered the degree of contribution to the authentication result, the identifiability being such that, based on collation performed within the registration database 8, for example, the similarity with respect to the second feature information 6-2 is high at the time of collation of the subject person whereas the similarity based on collation between two persons whose items of second feature information 6-2 are not to correspond is decreased. With regard to the order of the second feature information 6-2 when performing collation using the second feature information 6-2, a unique order may be set for each registered person, or a fixed order of the second feature information 6-2 may be set in the registration database 8.

In the present embodiment, the second feature information 6-2 having high correlation between two different finger blood vessel images is extracted. However, the third feature information having high correlation between three or more different finger blood vessel images may be extracted. The first feature information 6-1 and the second feature information 6-2 may include information about certain specific feature points in a blood vessel image or brightness changes in a blood vessel image with grey scale representation. The first feature information 6-1 and the second feature information 6-2 may be respectively extracted from different biometric modalities (such as blood vessel, fingerprint, palm print, palm shape, nail shape, face, ear shape, iris, retina, and gait).

### Third Embodiment

The first and the second embodiments have been described with reference to examples where the second feature information 6-2 having high correlation value (similarity) between two persons is extracted and utilized for collation, so as to authenticate an individual. By utilizing the second feature information 6-2 in addition to the first feature information 6-1, highly accurate authentication can be performed. Meanwhile, as the number of data items registered in the registration database 8 on the server and the like increases, the speed of authentication may become lowered. Thus, in the present embodiment, a method for performing authentication with high accuracy and at high speed by utilizing a feature having high similarity between a plurality of persons will be described.

According to the first and the second embodiments, the second feature information 6-2 is provided by a biometric modality feature having high similarity between two persons. In the present example, third feature information (group feature information) 6-3 acquired on the basis of correlation between the biometric modality information of three or more different persons is utilized. The third feature information 6-3 is feature information exhibiting high correlation value (similarity) between three or more persons. The third feature information 6-3 may be provided by feature information having low correlation value (similarity) between the three or more persons. The meaning of “high (or low) correlation value” is the same as described above. By utilizing the co-occurrence where a plurality of similarities obtained by collation of the third feature information 6-3 having high similarity commonly among three or more persons with a plurality of persons is simultaneously increased, not only can an individual be authenticated but also a group to which the individual belongs can be identified.

For example, in a scene where a plurality of authentication-requesting persons makes a line waiting for authentication, and the persons are authenticated one after another, it can be expected that a plurality of authentication-requesting persons belonging to the same group is waiting in the same line together. Thus, a plurality of temporally and spatially close authentication-requesting persons is collated with the third feature information 6-3. If a plurality of high similarities is obtained, the likelihood is very high that a plurality of authentication-requesting persons belonging to a certain specific group is there. Thus, when a certain authentication-requesting person can be authenticated and the group to which the authentication-requesting person belongs can be identified, the likelihood is high that the authentication-requesting persons that are going to be authenticated include persons belonging to that group. Accordingly, immediately after the group is identified, a locationally and temporally close authentication-requesting person is preferentially collated with the registered data of the persons belonging to that group. In this way, the probability is increased that collation with the registered data of a correct authentication-requesting person can be performed at an increased speed.

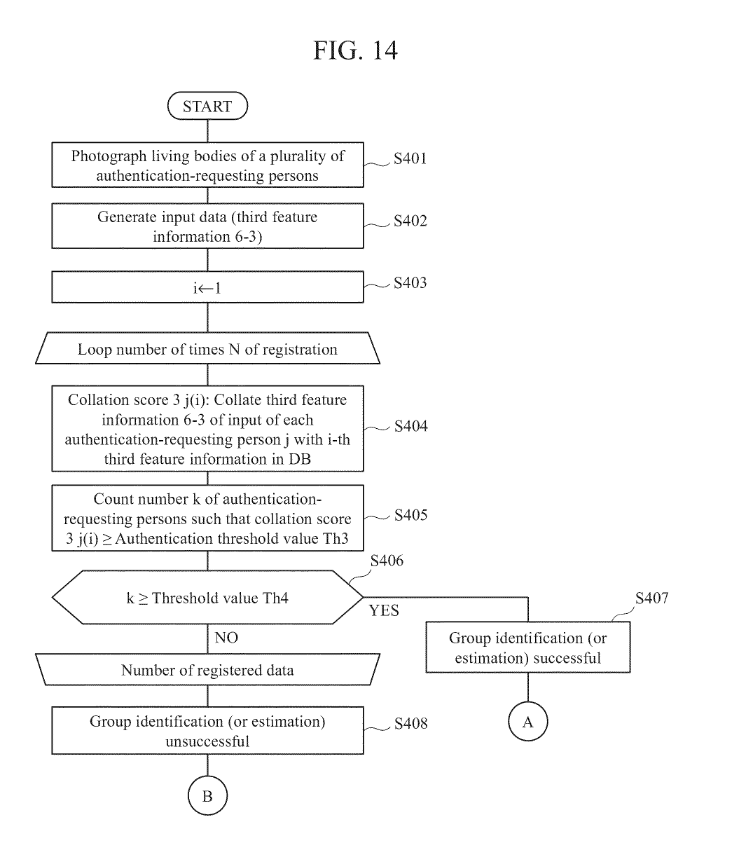

FIG. 14 shows an example of a flowchart for identifying a group to which an authentication-requesting person belongs by utilizing the third feature information 6-3 having high similarity between a plurality of persons.

First, living bodies of a plurality of authentication-requesting persons j are photographed by the measurement device 12 simultaneously or at short predetermined time intervals (S401). Then, the image input unit 18 generates the third feature information 6-3 as input data from the biometric modality information of each of the authentication-requesting persons (S402). The authentication unit 101 then initializes the variable i identifying the registered data to 1 for collation process initialization (S403). The variable i corresponds to the order of arrangement of registered data. When i is 1, the initial registered data is indicated; when the number of registered data items is N, the last registered data is indicated.

Then, the authentication unit 101 collates the third feature information 6-3, which is the generated input data, with the third feature information 6-3, which is the i-th registered data on the registration database 8, and calculates a collation score 3 j(i) (S404). The authentication unit 101 then counts the number k of the authentication-requesting persons of which the collation score 3 j(i) is greater than a preset authentication threshold value Th3 (S405). The authentication unit 101 determines whether the number k of the authentication-requesting persons is equal to or greater than a preset threshold value Th4 (S406). Herein, by performing the determination using the threshold value Th4, it can be determined whether a certain number of persons in the group are being authenticated simultaneously or at short predetermined time intervals. For example, four persons belong to a certain group. By setting the threshold value Th4 to “3”, it can be determined that, even if not all of the persons of the group satisfy the determination of step S406, the likelihood is high that the remaining persons of the group are also being authenticated, whereby the group can be estimated.

When the number k of the authentication-requesting persons is equal to or greater than the threshold value Th4, the authentication unit 101, assuming that the authentication-requesting persons of which the collation score 3 is greater than the authentication threshold value Th3 belong to a group i, identifies the group (S407). When the number k of the authentication-requesting persons is below the threshold value Th4, the authentication unit 101 performs collation with next registered data. As a result of collation with the last registered data N, if the number k of the authentication-requesting persons is below the threshold value Th4, it is determined that the group identification is unsuccessful because of the absence of registered data to be collated (S408).

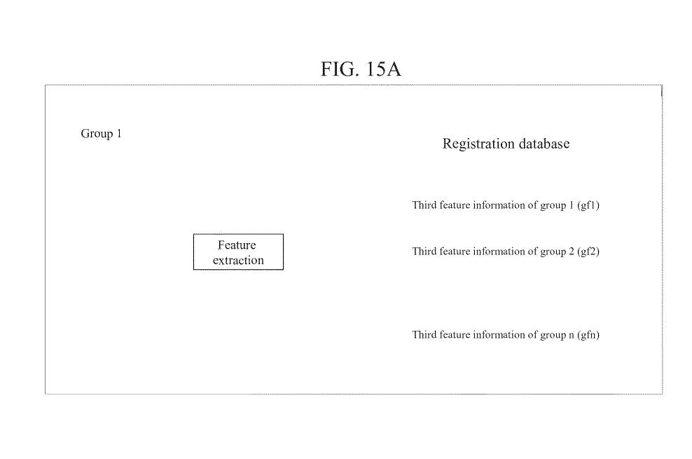

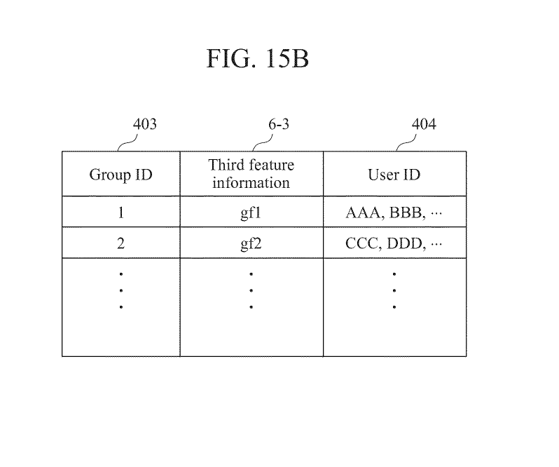

FIG. 15A shows a diagram for describing a method of extracting the third feature information 6-3 of a group. There are five persons p1, p2, p3, p4, and p5 belonging to a group 1. The registration unit 102 extracts the third feature information 6-3 (gf1) having high similarity commonly to the five, and registers the third feature information 6-3 (gf1) in the registration database 8. Because the third feature information 6-3 is different from one group to another, the third feature information 6-3 for each group (gf1, gf2, . . . , gfn) is registered.

FIG. 15B shows a specific example of the registration database 8. The registration database 8 is provided with a second table including an identifier (group ID) 403 for identifying each group, the third feature information 6-3, and an identifier (user ID) 404 of users belonging to the group. For example, the information in the identifier 404 of the users belonging to a group corresponds to ID 401 of FIG. 4B. Thus, it is possible, after the group is identified by utilizing the third feature information 6-3, to authenticate each individual using the information of FIG. 4B.

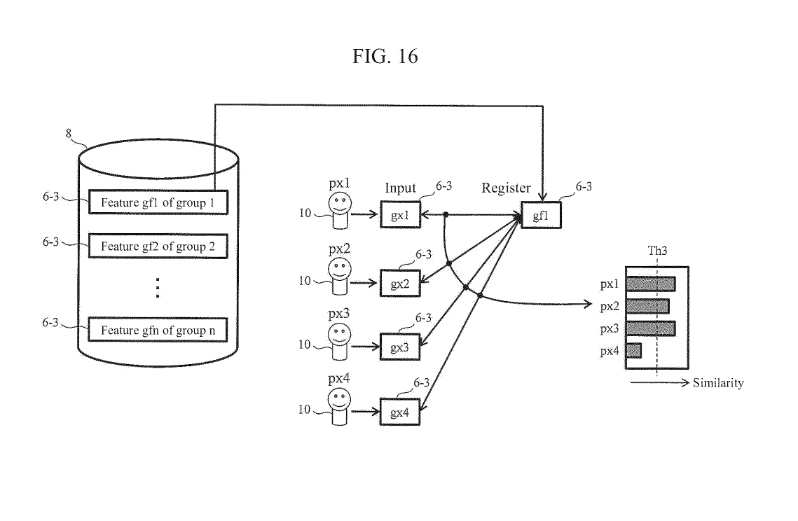

FIG. 16 is a diagram for describing a group identifying method. The method will be described with reference to an example in which four temporally and spatially close authentication-requesting persons px1, px2, px3, and px4 are authenticated. The authentication unit 101 calculates a plurality of similarities by collating the third feature information 6-3 (gf1) of group 1 registered in the registration database 8, with each item of the third feature information (gx1, gx2, gx3, gx4) obtained from the biometric modality information of the four authentication-requesting persons. Of the calculated four similarities, the three similarities obtained by collation with px1, px2, and px3 are higher than the authentication threshold value Th3. When the number of persons satisfying the authentication threshold value Th3 is equal to or greater than the threshold value Th4, the authentication unit 101 determines that the three persons px1, px2, and px3 except for px4 belong to group 1. With respect to px4, it is not determined herein that person px4 belongs to group 1 because the similarity of px4 is smaller than the authentication threshold value Th3. However, the subsequent process may be performed assuming that person px4 will belong to group 1. The biometric modality information obtained from each person during authentication may contain noise and the like, preventing correct determination. Thus, px4 may be handled as belonging to group 1 as described above by giving priority to the fact that the person has been authenticated simultaneously or at short time intervals with those who do belong to group 1.

In the example of FIG. 16, it is only known that px1, px2, and px3 belong to group 1, and it is not authenticated which persons belonging to group 1 they are. Thus, if the individuals are to be authenticated, it is necessary to separately perform collation with the first feature information 6-1 and the second feature information 6-2 of the persons belonging to group 1, and to authenticate the authentication-requesting persons individually. However, because it is only necessary to perform collation with a small number of items of feature information narrowed from all of the registered data, namely, the first feature information 6-1 and the second feature information 6-2 of the persons belonging to group 1, the collation time can be decreased.

### Fourth Embodiment

When the third feature information 6-3 (gf1) of group 1 is registered, an extraction property, such as the position of extraction of the third feature information 6-3 or the region size of the third feature information 6-3, may also be registered. As in the above-described case, the extraction property refers to attribute information for extracting, from the input information, the third feature information 6-3 as the object of collation with the third feature information 6-3 in the registration database 8. For example, the third feature information 6-3 includes information about biometric location, extraction position, or region size and the like.

Depending on the person in the group, the extraction property representing the attribute information such as the biometric location, extraction position, or region size for extraction of the third feature information 6-3 may vary. Thus, the registration unit 102 registers the extraction property of the third feature information 6-3 in the registration database 8 for each person in the group. In this way, it becomes possible to uniquely extract the third feature information 6-3 from an arbitrary authentication-requesting person px using the extraction property, and to collate it with the third feature information 6-3 registered in the registration database 8.

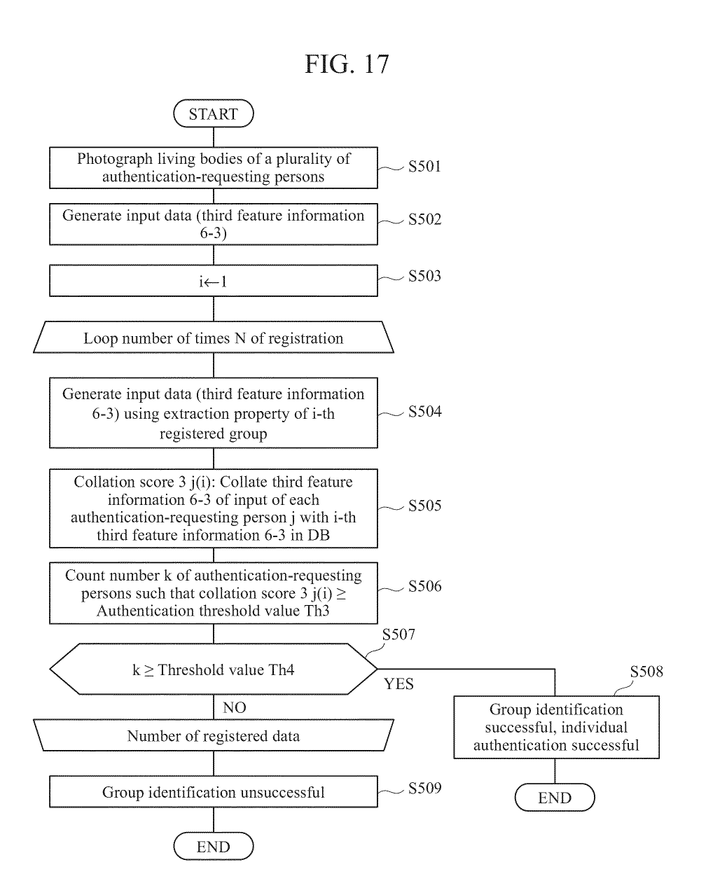

FIG. 17 shows an example of a flowchart for identifying a group to which an authentication-requesting person belongs by using the third feature information 6-3 and the extraction property in combination.

First, the living bodies of a plurality of authentication-requesting persons j are photographed by the measurement device 12 simultaneously or at short time intervals (S501). The image input unit 18 generates the third feature information 6-3 from the biometric modality information of each of the authentication-requesting persons as input data (S502). The authentication unit 101 initializes the variable i identifying the registered data to 1 for collation process initialization (S503). The variable i corresponds to the order of arrangement of registered data. When i is 1, the initial registered data is indicated; when the number of registered data items is N, the last registered data is indicated.

Then, the image input unit 18, utilizing the extraction property of the third feature information 6-3 of the i-th registered group i in the registration database 8, generates the third feature information 6-3 from the biometric modality information of each of the authentication-requesting persons j as input data (S504). The authentication unit 101 then collates the third feature information 6-3, which is the generated input data, with the third feature information 6-3, which is the i-th registered data in the registration database 8, and calculates a collation score 3 j(i) (S505). Then, the authentication unit 101 counts the number k of the authentication-requesting persons of which the collation score 3 j(i) is greater than the preset authentication threshold value Th3 (S506). The authentication unit 101 then determines whether the number k of the authentication-requesting persons is equal to or greater than the preset threshold value Th4 (S507).

If the number k of the authentication-requesting persons is equal to or greater than the threshold value Th4, the authentication unit 101, determining that the authentication-requesting persons of which the collation score 3 is greater than the authentication threshold value Th3 belong to group i, identifies the group. Simultaneously, the authentication unit 101, with respect to the authentication-requesting persons of which the collation score 3 is greater than the authentication threshold value Th3, performs individual authentication (S508). If the number k of the authentication-requesting persons is below the threshold value Th4, the authentication unit 101 performs collation with the next registered data. As a result of collation with the last registered data N, if the number k of the authentication-requesting persons is below the threshold value Th4, the authentication unit 101 determines that the group identification is unsuccessful because of the absence of registered data for collation (S509).

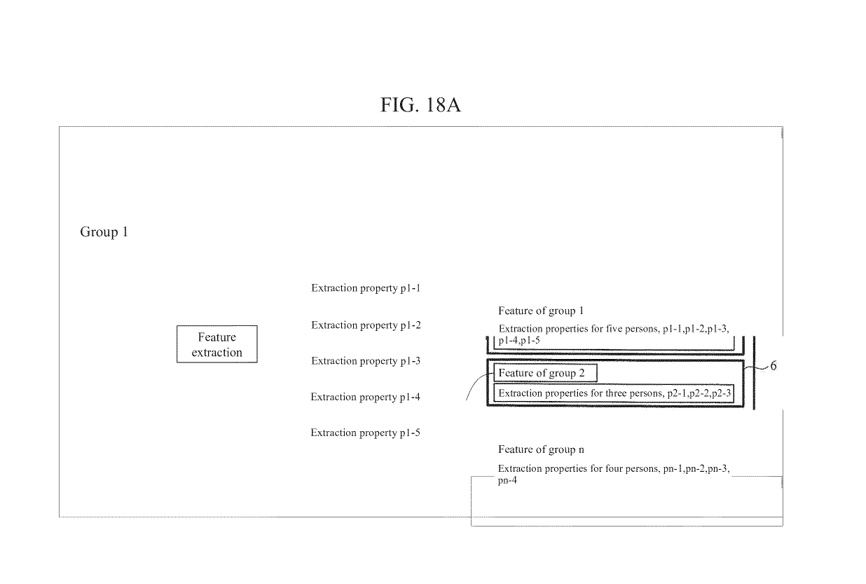

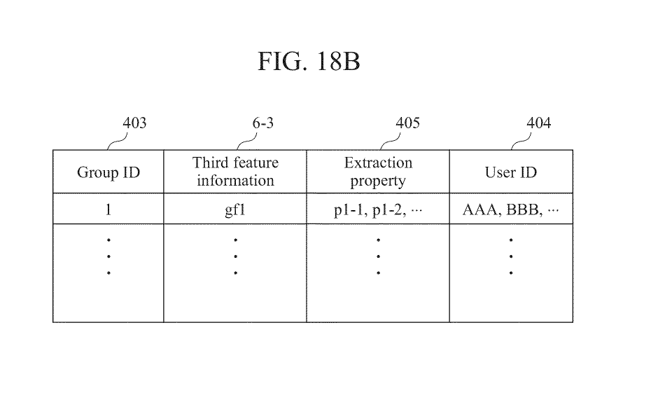

FIG. 18A is a diagram for describing a method of extracting the third feature information 6-3 of a group. There are five persons p1, p2, p3, p4, and p5 who belong to group 1. The registration unit 102 extracts the third feature information 6-3 (gf1) having high similarity commonly among the five persons, and also extracts the extraction property of the third feature information 6-3 of each person. The registration unit 102 registers the combination of the third feature information 6-3 (gf1) and the extraction property in the registration database 8. Because the extraction property of the third feature information 6-3 is different from one person to another, the extraction property of the third feature information 6-3 of each person (p1-1, . . . , p1-5) is registered.

FIG. 18B shows a specific example of the registration database 8. The registration database 8 is provided with a third table including an identifier (group ID) 403 for identifying each group, the third feature information 6-3, an extraction property 405 for extracting the third feature information 6-3, and an identifier (user ID) 404 of a user corresponding to each extraction property 405. In the illustrated example, “p1-1” of the extraction property 405 corresponds to “AAA” of the user identifier 404. Thus, the extraction property 405 is stored in correspondence with the user identifier 404. Accordingly, the third feature information unique to each person can be extracted using the extraction property 405, and collated with the third feature information 6-3 in the registration database 8. In this way, when the group is identified, the persons can also be simultaneously identified.

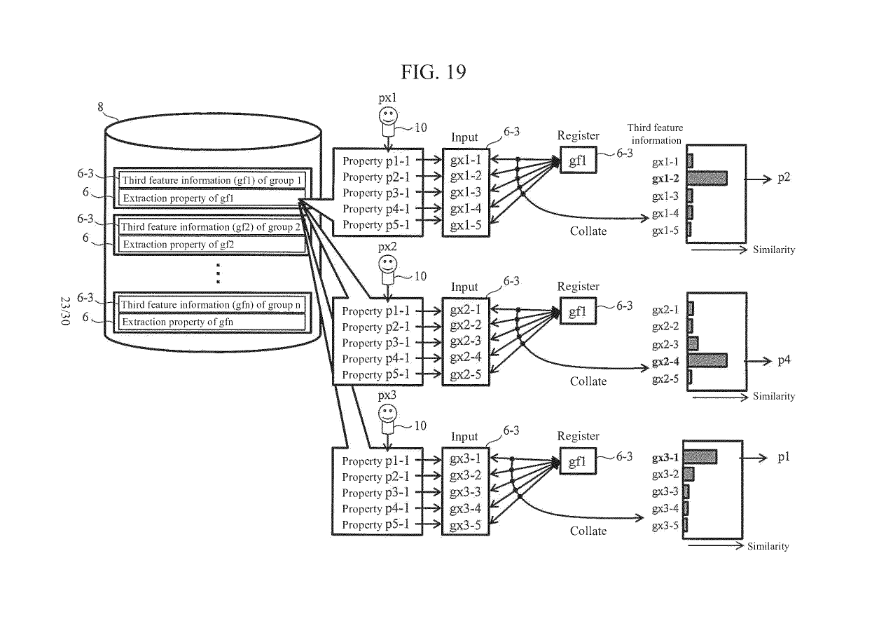

FIG. 19 is a diagram for describing group identification and individual identification. It is assumed that the authentication-requesting persons px1, px2, and px3 are together. Herein, the authentication unit 101 collates the third feature information 6-3 (gf1) of group 1 consisting of five persons (p1, p2, p3, p4, p5) with the third feature information extracted from the authentication-requesting persons px1, px2, and px3. The extraction properties (p1-1, p2-1, p3-1, p4-1, p5-1) respectively correspond to the persons p1, p2, p3, p4, and p5.

First, the image input unit 18, using the extraction properties (p1-1, p2-1, p3-1, p4-1, p5-1) for uniquely extracting the third feature information 6-3 from each person belonging to group 1, extracts the respective third feature information 6-3 items (gx1-1, gx1-2, gx1-3, gx1-4, gx1-5) from person px1. In this case, because the position or size of the extracted feature varies depending on the extraction properties (p1-1, p2-1, p3-1, p4-1, p5-1), the third feature information 6-3 (gx1-1, . . . , gx1-5) also varies. Thus, the third feature information 6-3 (gx1-1, . . . , gx1-5) extracted from the respective extraction properties (p1-1, p2-1, p3-1, p4-1, p5-1) is handled in a distinguished manner.

The authentication unit 101 collates a plurality of items of the third feature information (gx1-1, . . . , gx1-5) extracted from person px1 respectively with the third feature information 6-3 (gf1) of group 1 registered in the registration database 8, and calculates similarity.

In the example of FIG. 19, the similarity based on collation of the third feature information 6-3 (gx1-2) extracted from the authentication-requesting person px1 with the registered third feature information 6-3 (gf1) is higher than the other similarities. Likewise, the similarity based on collation of the third feature information 6-3 (gx2-4) extracted from the authentication-requesting person px2 with the registered third feature information 6-3 (gf1) is higher than the other similarities. Further, the similarity based on collation of the third feature information 6-3 (gx3-1) extracted from the authentication-requesting person px3 with the registered third feature information 6-3 (gf1) is higher than the other similarities. Because there is the co-occurrence of high similarities, the authentication unit 101 can determine that the three persons px1, px2, and px3 belong to group 1. Further, with respect to person px1, the similarity based on collation of the third feature information 6-3 (gx1-2) extracted using the extraction property p2-1 with the registered third feature information 6-3 (gf1) is high. Thus, the authentication unit 101 can authenticate person px1 as being person p2. Based on a similar decision, person px2 can be authenticated as being person p4, and person px3 can be authenticated as being person p1.

The examples of FIG. 16 and FIG. 19 have been described with reference to the case where group identification is performed using the third feature information 6-3 common to three or more persons, and the case where both group identification and individual authentication are performed. However, these are not limitations. For example, in addition to the authentication based on the third feature information 6-3, it is also possible to perform authentication based on a combination of the first feature information 6-1 independently extracted from one item of biometric modality information, as described with reference to the first embodiment, and the second feature information 6-2 extracted such that the similarity between two persons is increased. Further, based on the result of previous collation with the first feature information 6-1, the persons for whom collation with the other, third feature information 6-3 is performed may be limited, whereby an increase in speed can be achieved by eliminating redundant collation while high authentication accuracy is maintained. Conversely, based on the result of previous collation with the third feature information 6-3, the persons for whom collation with the other, first feature information 6-1 is performed may be limited, whereby an increase in speed can be achieved while high authentication accuracy is maintained.

It is also possible to perform highly accurate authentication by combining similarities based on collation using the first feature information 6-1, the second feature information 6-2 exhibiting high correlation between two persons, and the third feature information 6-3 exhibiting high correlation between three or more persons. For example, the similarity calculated by collation of the third feature information 6-3, and the similarity calculated by collation of the first feature information 6-1 and the second feature information 6-2 may be integrated, whereby highly accurate authentication can be performed.

### Fifth Embodiment

In the following, an example in which the third feature information 6-3 and the first feature information 6-1 (or the second feature information 6-2) are used in combination will be described. In this configuration, authentication speed and convenience can be improved while authentication accuracy is ensured.

In the examples of FIG. 16 and FIG. 19, the group to which the authentication-requesting person belongs is identified by collation with the third feature information 6-3 of each group registered in the registration database 8. Meanwhile, as the number of the items of the registered third feature information 6-3 becomes very large, the number of times of collation with the third feature information 6-3 also increases, resulting in an increase in the time before group identification is made. Thus, in a scene where a plurality of authentication-requesting persons belonging to the same group attempts authentication one after another, initially a person is authenticated with the first feature information 6-1, and the group to which the person belongs is identified from the authenticated person. In this way, the time required for identifying the group can be decreased. After the group is identified, the likelihood is high that the remaining authentication-requesting persons include persons belonging to the identified group. Thus, the third feature information 6-3 and the first feature information 6-1 of the identified group are used in combination. In this way, highly accurate and high-speed authentication can be performed.

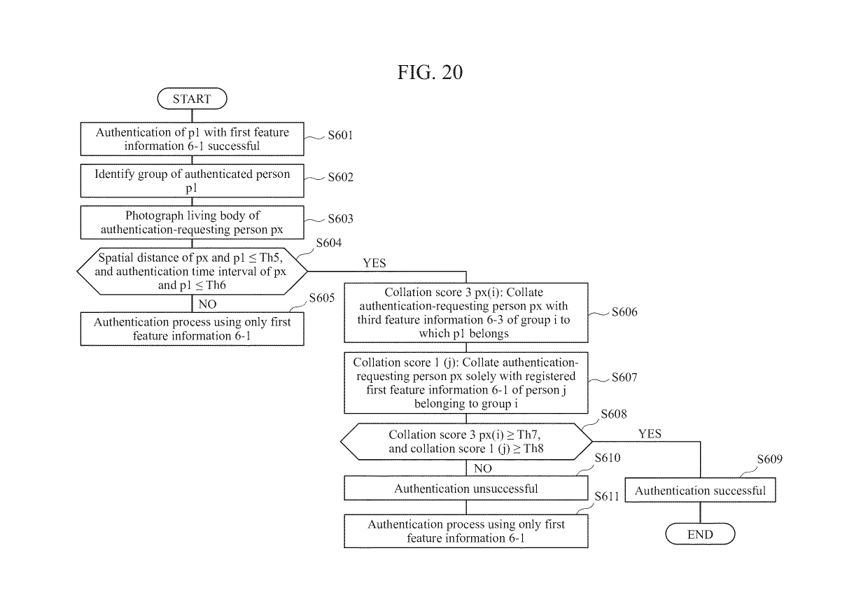

FIG. 20 is an example of a flowchart for initially authenticating an individual with the first feature information 6-1 and then identifying the group to which the authenticated person belongs. In this configuration, efficient authentication can be performed by limiting the authentication to the persons belonging to the identified group.

First, the authentication unit 101 authenticates person p1 with the first feature information 6-1 (S601). Then, the authentication unit 101 identifies the group to which the authenticated person p1 belongs (S602). For example, as shown in the first table of FIG. 4B and the second table of FIG. 15B, when the first table and the second table are associated by the user ID, the group to which the authenticated person belongs can be identified after authentication with the first feature information 6-1, and then authentication with the third feature information 6-3 can be performed.

The measurement device 12 photographs the living body of at least one authentication-requesting person px, and acquires the biometric modality information of each authentication-requesting person px (S603). Then, the authentication unit 101 determines whether the spatial distance between the authentication-requesting person px and the authenticated person p1 is smaller than Th5, and whether the authentication time interval of the authentication-requesting person px and the authenticated person p1 is shorter than Th6 (S604). The spatial distance between the authentication-requesting person px and the authenticated person p1 may be determined using the distance between the authentication gates used for authentication of each person. For example, when there is a plurality of authentication gates, the storage device 14 may store information about the distance between the authentication gates. For example, when the authentication-requesting person px is authenticated at the same gate as or an adjacent gate to the gate used for authentication of the authenticated person p1, the authentication unit 101 may determine that the spatial distance condition in step S604 is satisfied.

The authentication-requesting person px who does not satisfy the condition of step S604 is determined to belong to a group different from that of the authenticated person p1, and the process proceeds to step S605. In this case, the authentication unit 101 performs an authentication process for the authentication-requesting person px by utilizing only the first feature information 6-1 (S605).

When the condition of step S604 is satisfied, the process proceeds to step S606. The authentication unit 101 collates the third feature information 6-3 of group i to which person p1 belongs with the third feature information extracted from person px to calculate a collation score 3 px(i) (S606). Then, the authentication unit 101 acquires the first feature information 6-1 from the registration database 8 with respect only to each person j who belongs to group i. The authentication unit 101 collates the first feature information 6-1 of each person j who belongs to group i with the first feature information extracted from person px to calculate a collation score 1 (j) (S607).

The authentication unit 101 determines whether the calculated collation score 3 px(i) and collation score 1 (j) are respectively greater than an authentication threshold value Th7 and an authentication threshold value Th8 (S608). If the condition of step S608 is satisfied, the authentication unit 101 determines that authentication of the authentication-requesting person is successful (S609). If the condition of step S608 is not satisfied, the authentication unit 101 determines that the authentication is unsuccessful (S610). In this case, the authentication unit 101 acquires the first feature information 6-1 of a person of a group other than group i from the registration databases 8, and collates the person's first feature information 6-1 with the first feature information extracted from person px (S611).

According to the above configuration, group i is identified from the initially authenticated person p1, and then the authentication-requesting person px is collated using the third feature information 6-3 of group i and the first feature information 6-1 of a person belonging to group i, whereby the speed of authentication is increased. Further, because the third feature information 6-3 and the first feature information 6-1 are used in combination, compared with the case where authentication is performed using solely the first feature information 6-1, the accuracy of the authentication system as a whole can be maintained even when the authentication threshold value Th8 in step S608 is lowered. Conventionally, because authentication is performed using solely the first feature information 6-1, the authentication threshold value needs to be set high so as to maintain authentication system accuracy. In contrast, according to the present embodiment, authentication using the third feature information 6-3 can be additionally performed by identifying the group of the authentication-requesting person in advance. Thus, the accuracy of the authentication system as a whole can be maintained even when the authentication threshold value Th8 for the first feature information 6-1 is lowered.

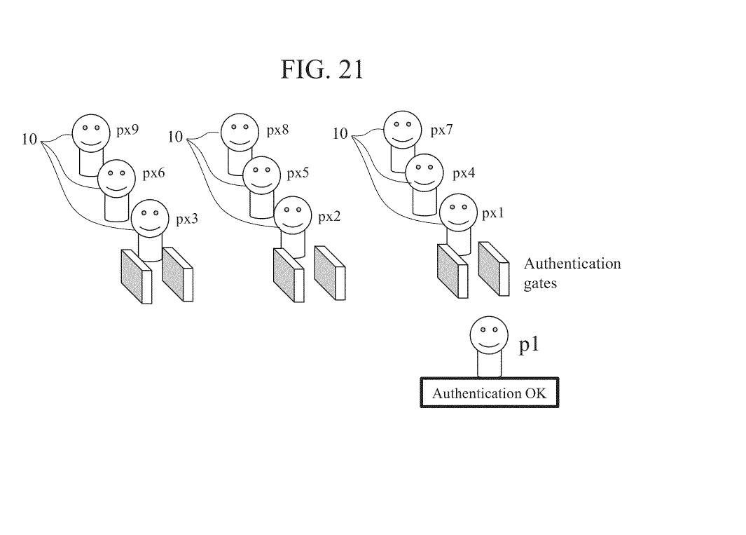

FIG. 21 is a diagram for describing an example of the combined use of the third feature information 6-3 and the first feature information 6-1. In the present example, the first feature information 6-1 is extracted from a finger blood vessel image, and the third feature information 6-3 is extracted from a facial image. FIG. 21 illustrates a scene in which a plurality of authentication-requesting persons px1 to px9 are lined up at three authentication gates waiting for authentication. The plurality of authentication-requesting persons px1 to px9 passes the spatially close authentication gates, where the temporally interval of authentication between the plurality of authentication-requesting persons px1 to px9 is small.

First, at the authentication gates, authentication is performed by extracting the first feature information 6-1 from the finger blood vessel image acquired by the measurement device 12. While waiting in the authentication-waiting lines, authentication is performed by extracting the third feature information 6-3 (face feature) from the facial image acquired by the measurement device 12.

It is assumed that one person has been initially authenticated with the first feature information 6-1, and that a group 2 to which the authenticated person p1 belongs and the third feature information 6-3 (gf2) of group 2 have been identified. If it is assumed that person p1 came to the authentication gates with a plurality of persons of group 2 to which person p1 belongs, the persons px1 to px9 lined up at the three authentication gates will include persons belonging to the same group 2 as person p1.

Thus, authentication is performed by performing collation with the third feature information 6-3 (gf2) of group 2 in the registration database 8 with respect solely to the persons px1 to px9 that are authenticated at the same authentication gate or at close authentication gates, immediately after person p1 is authenticated. At the authentication gates, collation using the first feature information 6-1 of the persons belonging to group 2 is preferentially performed. Collation is performed using the third feature information 6-3 (gf2) with respect solely to group 2 to which the authentication-requesting persons px1 to px9 are highly likely to belong, and collation using the first feature information 6-1 is performed with respect solely to the persons belonging to group 2. In this way, the probability is increased that collation with the registered data of the correct authentication-requesting persons can be performed with increased speed.

Further, by limiting the authentication-requesting persons to the authentication-requesting persons px1 to px9 immediately after person p1 is authenticated, the authentication threshold values for collation with the first feature information 6-1 and collation with the third feature information 6-3 in the registration database 8 can be lowered. Because the first feature information 6-1 and the third feature information 6-3 are used in combination, compared with the case where authentication is performed using solely the first feature information 6-1, the accuracy of the authentication system as a whole can be maintained even when the authentication threshold values for the first feature information 6-1 and the third feature information 6-3 are lowered. Thus, the frequency of rejection of the subject person at the authentication gate can be decreased. Further, because the authentication-requesting persons for whom the authentication threshold values are lowered are limited to temporally and spatially close persons, the risk of acceptance of the others in the authentication system as a whole can be reduced.

### Sixth Embodiment

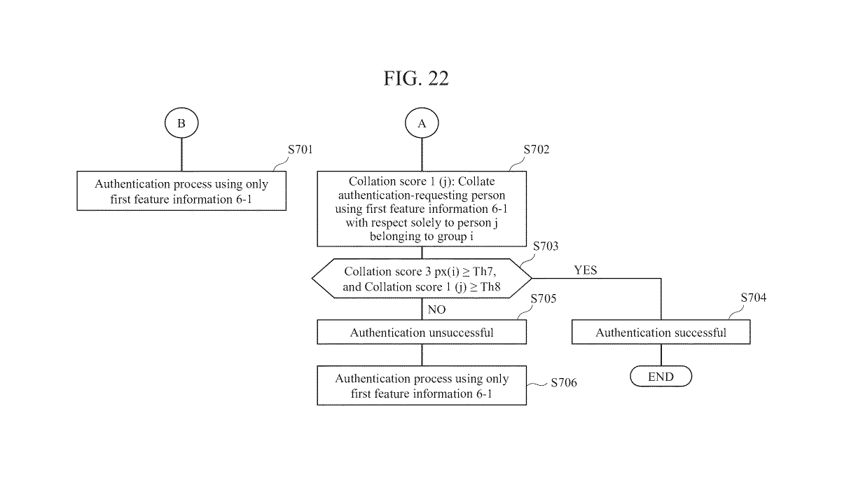

An example of combined use of the third feature information 6-3 and the first feature information 6-1 after collation by the third feature information 6-3 is performed and a certain group is identified will be described. FIG. 22 is a flowchart implemented after the flow of FIG. 14. Specifically, the flow “A” of FIG. 22 is implemented after “A” of FIG. 14, and the flow “B” of FIG. 22 is implemented after “B” of FIG. 14.

In this configuration, when high similarities are simultaneously obtained (co-occurrence) by collation of the third feature information 6-3 of a certain specific group with the third feature information extracted from a plurality of persons, collation by combined use of the third feature information 6-3 and the first feature information 6-1 is performed with respect to the persons associated with the co-occurrence of high similarities. In this way, highly accurate authentication can be performed.

Referring to FIG. 14, when the group is not identified, the authentication unit 101 performs an authentication process for the authentication-requesting person px by utilizing only the first feature information 6-1 (S701). On the other hand, when the group is identified (or estimated) in FIG. 14 (it is assumed herein that group i is identified), the authentication unit 101 acquires the first feature information 6-1 from the registration database 8 with respect solely to the person j belonging to group i. The authentication unit 101 collates the first feature information 6-1 of each person j belonging to group i with the first feature information extracted from person px, and calculates the collation score 1 (j) (S702).

Then, the authentication unit 101 determines whether the collation score 3 px(i) and the collation score 1 (j) calculated in the flow of FIG. 14 are respectively greater than the authentication threshold value Th7 and the authentication threshold value Th8 (S703). If the condition of step S703 is satisfied, the authentication unit 101 determines that the authentication of the authentication-requesting person is successful (S704). If the condition of step S703 is not satisfied, the authentication unit 101 determines that the authentication is unsuccessful (S705). In this case, the authentication unit 101 acquires the first feature information 6-1 of a person of a group other than group i from the registration database 8, and performs collation of the first feature information 6-1 with the first feature information extracted from person px (S706).

As illustrated in FIG. 21, in a scene where there are waiting lines (authentication-requesting persons px1 to px9) for authentication by finger blood vessel (the first feature information 6-1) at the authentication gates, the authentication-requesting persons px1 to px9 are slowly moving toward the authentication gates, and it often takes time before they arrive at the authentication gates. Thus, in the time before the persons arrive at the authentication gates, their facial images (the third feature information 6-3), which can be taken at a distance, are acquired from the authentication-requesting persons px1 to px9 and collation is performed using the third feature information 6-3, in order to identify or estimate the group to which the plurality of authentication-requesting persons belong.

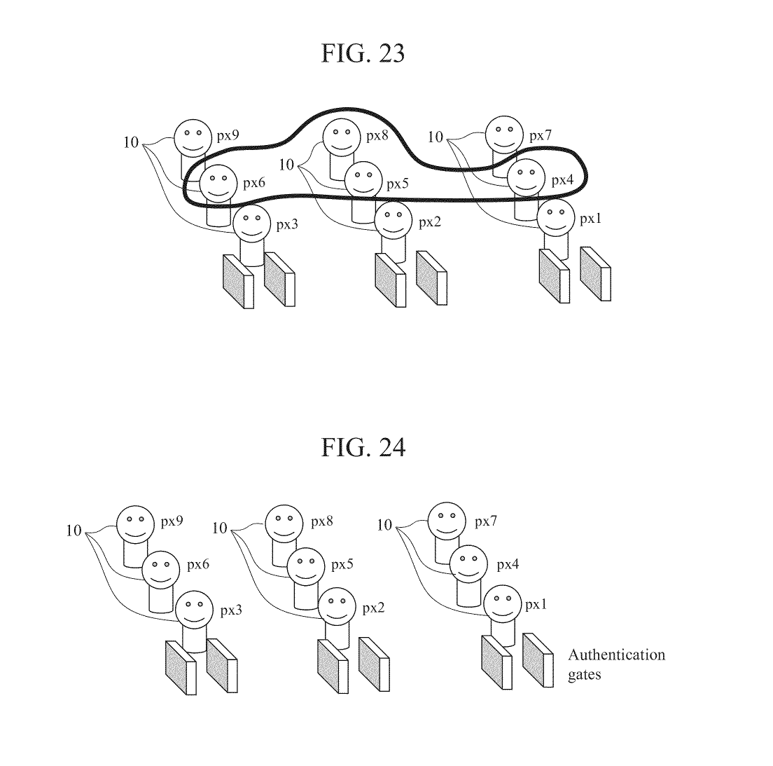

In the example of FIG. 23, it is assumed that, as a result of collation of the third feature information 6-3 (gf2) of group 2 with respect to the authentication-requesting persons px1 to px9, the similarities of the four persons px4, px5, px6, and px8 have simultaneously increased. Based on the level of similarity, it may be determined or estimated that the four belong to the same group 2. If the plurality of similarities calculated by collating the plurality of authentication-requesting persons with the third feature information 6-3 (gf2) of group 2 is greater than a preset threshold value, it can be learned that the authentication-requesting persons belong to group 2.

Even when the similarity of a certain person is below the threshold value, if the similarities of the other persons who have reached the authentication gates simultaneously or at short time intervals are high, it may be estimated that the person of which the similarity is below the threshold value belongs to the same group 2.

If the group of the authentication-requesting persons who arrived at the authentication gates is identified, and if the individuals have also been authenticated, they can pass the authentication gates. By integrating the result of collation of the third feature information 6-3 and the result of collation of the first feature information 6-1 at the authentication gates, highly accurate authentication can be performed.

In an example of FIG. 23, by using the first feature information 6-1 and the third feature information 6-3 in combination with respect to the four persons px4, px5, px6, and px8 that have been estimated to belong to group 2, compared with the case where the first feature information 6-1 is utilized by itself, the authentication threshold value for the similarity calculated by collation of the first feature information 6-1 can be lowered while suppressing the risk of acceptance of the others in the authentication system as a whole. Thus, the probability of rejection of the subject person at the authentication gate is lowered, and the throughput at the authentication gate is increased. Further, by performing collation with the first feature information 6-1 at the authentication gate only with respect to the persons of the group to which an authentication-requesting person is determined or estimated to belong, collation with the registered data of the correct authentication-requesting person can be performed at an increased speed.

While in the present embodiment the third feature information 6-3 is extracted from the face, the information may also be extracted from other biometric modalities that can be photographed contactlessly, such as the iris, palm print, or blood vessel. The first feature information 6-1, the second feature information 6-2, and the third feature information 6-3 may be respectively extracted from different modalities, such as blood vessel, fingerprint, palm print, palm shape, nail shape, face, ear shape, iris, retina, or gait.

In the present embodiment, an example of combined use of the first feature information 6-1 and the third feature information 6-3 has been described. However, the second feature information 6-2 and the third feature information 6-3 may be used in combination. Further, authentication may be performed by using the three items of information of the first feature information 6-1, the second feature information 6-2, and the third feature information 6-3.

The plurality of persons from which the third feature information 6-3 is extracted may be selected by various methods. For example, the third feature information 6-3 may be extracted from a plurality of persons who are often together. When a plurality of persons is authenticated together, the group to which the plurality of persons belong may be distinguished from another unspecified group by collation of the plurality of persons with the third feature information 6-3. The information about the group of the plurality of identified persons may be utilized for increasing the accuracy of individual authentication.

In another exemplary method of selecting the plurality of persons from which the third feature information 6-3 is extracted, a plurality of persons may be selected from a database in which an unspecified number of items of biometric modality information are stored. In this case, the selected persons and the number of the persons may be determined so that identifiability is increased in the database. Alternatively, the persons selected and the number of the persons may be determined so as to increase the speed of collation in the database by collation of the third feature information 6-3. The persons selected and the number of persons may be determined for other purposes.

### Seventh Embodiment

In the present embodiment, a group to which a plurality of persons belongs is registered in advance, and information about co-occurrence of a plurality of high similarities by collation with the first feature information 6-1 is utilized. In this configuration, authentication accuracy can be increased.

In the sixth embodiment, the example has been described in which the group to which persons belong is identified (or estimated) by collation of the third feature information 6-3 common to a plurality of persons, and the information about the group is utilized for individual authentication. In the present embodiment, the information about which persons belong to a certain group, and the co-occurrence relationship of similarities by the collation of the first feature information 6-1 extracted only from the biometric modality information of the subject person are utilized. In this way, it becomes possible to increase the accuracy of group identification and individual authentication.

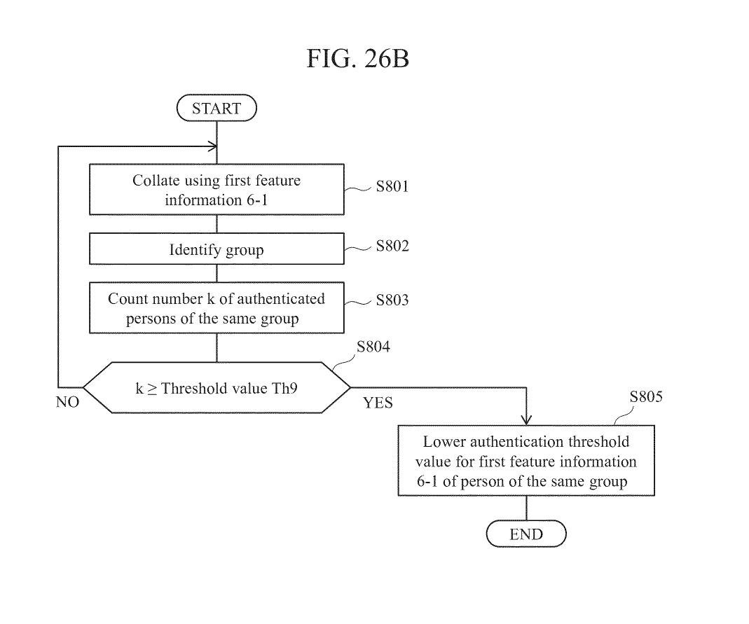

FIG. 26A illustrates an example of a table in the registration database 8 according to the present embodiment. The registration database 8 is provided with a fourth table including an identifier (user ID) 410 for identifying each user, the first feature information 6-1, and an identifier (group ID) 411 for identifying each group.

First, as illustrated in FIG. 24, a scene is considered in which the authentication-requesting persons px1 and px2, . . . , px9 are waiting to pass the three authentication gates. In this case, the persons px1 to px9 include the four persons p1, p2, p3, and p4 who belong to the same group 1. Three authentication waiting lines are formed at the three authentication gates. Initially, in order to perform authentication of px1, px2, and px3 at the respective gates, collation by the first feature information 6-1 is performed.

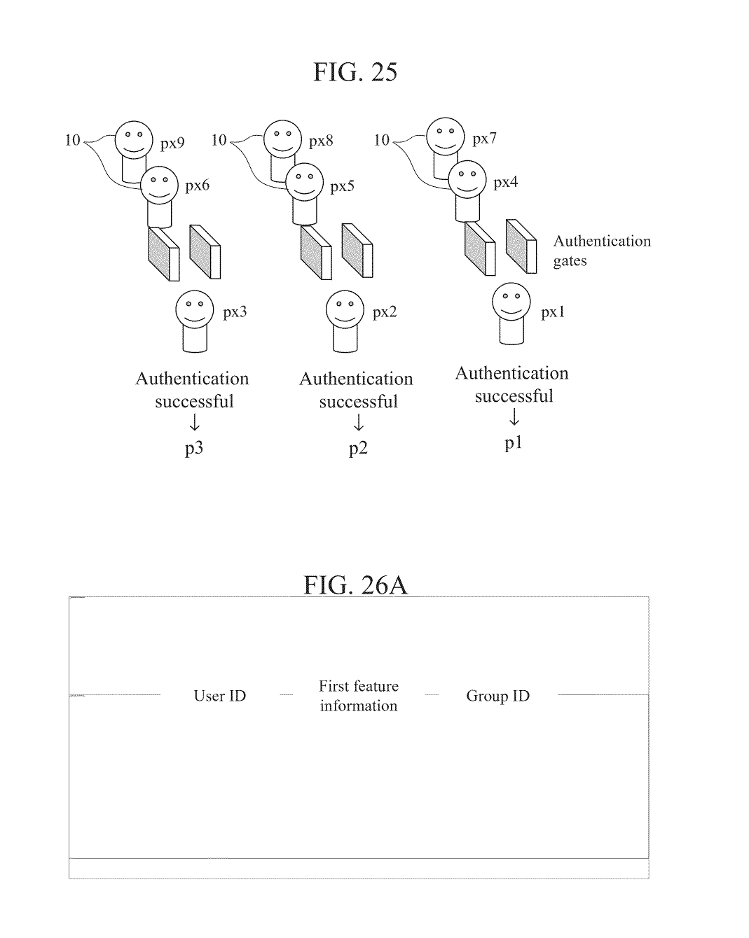

As illustrated in FIG. 25, when the authentication unit 101 calculates similarity by collation with the first feature information 6-1(f1) of a person belonging to group 1, high similarity is obtained with respect to person px1. Thus, person px1 is authenticated as being person p1. Similarly, person px2 is authenticated as being person p2 on the basis of the level of similarity by collation with the first feature information 6-1(f2). Person px3 is authenticated as being person p3 on the basis of the level of similarity by collation with the first feature information 6-1(f3).

At this point in time, person p4 who belongs to group 1 is not yet authenticated. In this scene, because three of the four persons of group 1 have been authenticated, the probability is high that person p4 who belongs to group 1 and who is not yet authenticated is included in the persons px4 to px9 who are going to be authenticated. In this case, it is assumed that, as a result of collation of person px5 with the first feature information 6-1(f4) of person p4, the similarity is slightly below the authentication threshold value (namely, the similarity is smaller than the authentication threshold value by a predetermined value). Here, it is assumed that person px5 is person p4 by utilizing the result of the previous authentication of the persons p1, p2, and p3 of the same group 1, and person px5 is authenticated as being person p4. Namely, because person p4 is temporally and spatially close to the persons p1, p2, and p3 of the same group 1, the authentication condition is set lower for a predetermined time.

FIG. 26B is an example of a flowchart of the authentication process according to the present embodiment. The authentication unit 101 collates the first feature information 6-1 acquired from the biometric modality information of the authentication-requesting person with the first feature information 601 of the registration database 8 to authenticate the individual (S801). Herein, as illustrated in the example of FIG. 25, it is assumed that px1 to px3 have been respectively authenticated as being p1 to p3. The authentication unit 101, by referring to the table of FIG. 26A, identifies the group to which the persons p1 to p3 belong after the individual authentication (S802).

The authentication unit 101 then counts the number k of the authenticated persons of the same group (group 1) (S803). Herein, the number k of the authenticated persons is “3”. When the number k of the authenticated persons is equal to or greater than the threshold value Th9, the authentication unit 101 proceeds to step S805. In this case, the authentication unit 101 sets the authentication threshold value for the first feature information 6-1 of the person (herein, p4) of the same group smaller by a predetermined value for a predetermined time (S805).

When the condition of S804 is not satisfied, the process from step S801 is repeated. With regard to the process of S801 to S804, when the predetermined time elapsed, the value of the number k of the authenticated persons is reset. This is so that the authentication threshold value for the first feature information 6-1 is lowered only when the group is identified by a plurality of temporally and spatially close authentication-requesting persons.

In the above example, the result of the previous authentication of the persons p1, p2, and p3 of the same group 1 is utilized to presumably authenticate person px5 as being person p4. If the person is authenticated as being person p4 while the authentication threshold value is simply lowered at all times, the probability of erroneously authenticating a person who is not actually person p4 may be increased. However, authentication of the person who belongs to group 1 and who is yet to be authenticated is made easier only for the temporally and spatially close person who is authenticated immediately after the previous authentication of a plurality of persons of group 1. In this way, the number of times of collation while the authentication threshold value is lowered can be minimized, whereby the probability of erroneous authentication of the others can be decreased.

It is also possible to utilize a plurality of different items of the first feature information 6-1, and to perform multimodal authentication utilizing the co-occurrence relationship of similarities by the collation of the respective items of the first feature information 6-1. For example, two different items of the first feature information 6-1 are respectively the first feature information 6-1-1 and the first feature information 6-1-2. Herein, the first feature information 6-1-1 is a feature that has low identification capacity but that can be robust with respect to posture variations and the like, and be extracted at a distance. On the other hand, the first feature information 6-1-2 is a feature that provides high identification capacity as long as it can be extracted in a correct posture and in a stationary state.

By utilizing the co-occurrence relationship such that a plurality of similarities obtained by the collation of the first feature information 6-1-1 of the plurality of persons belonging to the same group with the plurality of authentication-requesting persons is simultaneously increased, the group to which the authentication-requesting persons belong can be identified or estimated. If the similarity calculated by collation of the first feature information 6-1-1 registered in the registration database 8 with the authentication-requesting person is higher than a preset threshold value, the authentication-requesting person can be authenticated and the group of the authenticated person can be identified. When the individual is authenticated and the group can be identified, the individual can pass the authentication gate.

On the other hand, with respect to an authentication-requesting person who is temporally and spatially close to a person who has been individually authenticated and whose group has been identified, the authentication-requesting person is not authenticated as an individual if the similarity calculated by collation with the first feature information 6-1-1 is slightly lower than the threshold value. However, the group to which the authentication-requesting person belongs can be estimated. With respect to the person who cannot be individually authenticated even by utilizing the co-occurrence relationship of high similarities by the collation of the first feature information 6-1-1, the result of estimation of the group and the first feature information 6-1-2 having higher identification performance than the first feature information 6-1-1 are used in combination. In this way, authentication accuracy can be increased.

In another example, the co-occurrence relationship of similarities as a result of collation by different features may be utilized for authentication, the relationship being such that high similarity is obtained for a certain person of a plurality of authentication-requesting persons belonging to the same group by collation of the first feature information 6-1-1, while high similarity is obtained for the other persons by collation of the first feature information 6-1-2.

### Eighth Embodiment

When cloud type biometric authentication via the network 7 as illustrated in FIG. 2 is assumed, a countermeasure for cyber-attack may be required. In the present embodiment, the biometric modality information of an individual is encoded, and a unique ID is generated from the code. While an example of generation of the unique ID from a finger blood vessel image will be described in the following, the unique ID may be similarly generated from other biometric modality information.

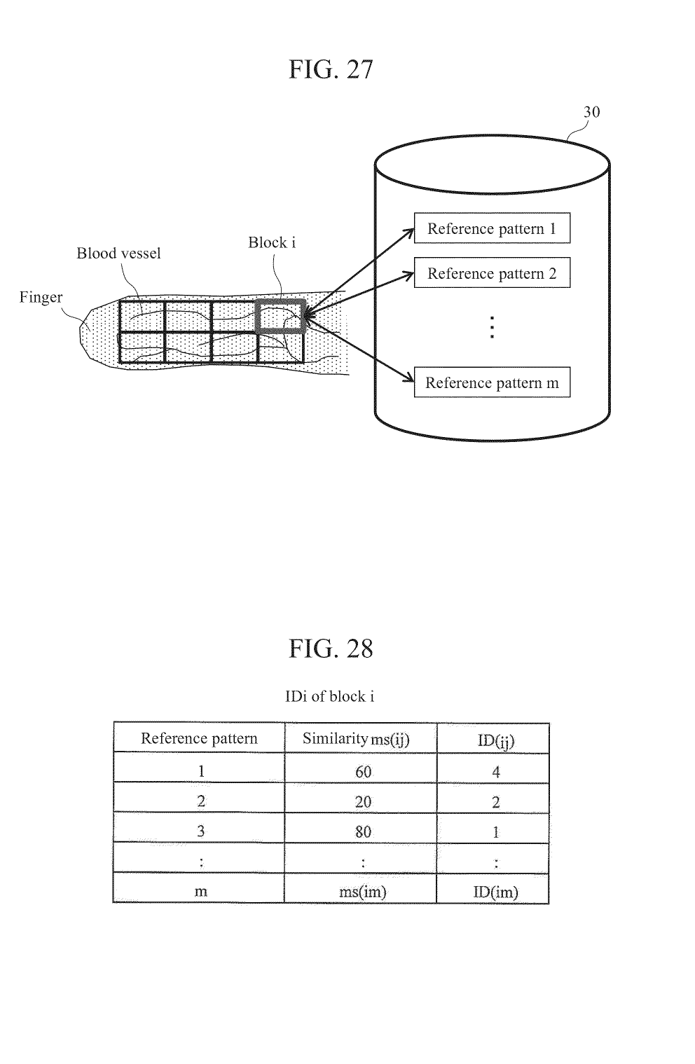

The authentication processing unit 13 is further provided with an ID generation unit that generates an ID from biometric modality information. For generating the ID, the authentication processing unit 13 is provided with a database 30 illustrated in FIG. 27. The database 30 is stored in a predetermined storage device. As illustrated in FIG. 27, in the database 30, there is stored a plurality (m) of reference patterns (blood vessel patterns) for collation with the finger blood vessel image of the authentication-requesting person. The reference patterns j (j=1 to m) are partial patterns having high similarity between a plurality of registered blood vessel patterns.

In the present example, it is assumed that, with respect to the finger blood vessel image that is captured, the influence of finger posture variations or lighting variations on a blood vessel pattern is normalized, and that the same blood vessel pattern region is cut out at all times. Namely, an ID is produced from the blood vessel pattern in a state such that the influence of finger posture variations and positional or lighting variations can be disregarded.

First, the finger blood vessel image of the authentication-requesting person is acquired by the measurement device 12. Thereafter, the ID generation unit divides the finger blood vessel image for producing an ID into a plurality (n) of blocks, as illustrated in FIG. 27. Then, the ID generation unit calculates similarity by collating each block i (i=1 to n) of the blood vessel pattern with the m reference patterns (blood vessel patterns) in the database.

The ID generation unit, as illustrated in FIG. 28, generates the ID(ij) from the similarity ms(ij) calculated by collating each block i with all of the reference patterns j. Transformation from the similarity ms(ij) to the ID(ij) may be performed according to a predetermined rule or by a predetermined function. For example, specific numbers may be allocated to a range of values of the similarity ms(ij). Alternatively, the value of the similarity ms(ij) may be substituted in a predetermined function to obtain a value as the ID(ij).

The ID generation unit generates an IDi by linking the generated ID(ij). The generated IDi of the block i is as follows.

IDi1|IDi2| . . . |IDim

where the symbol “|” means linking of the codes. For example, the IDij shown in FIG. 28 is linked in order from the top to provide the IDi of the block i.

The ID generation unit generates a final unique ID by linking the IDi. The unique ID for one finger is as follows.

ID1|ID2| . . . |IDn

The registration database 8 on the cloud in the present embodiment is managed with the above unique ID. Thus, the authentication processing unit 13 exchange information with the registration database 8 via the network 7 and using the generated unique ID. The finger blood vessel image as personal information is not transmitted over the network 7. Even if the information about the unique ID were to be leaked, the finger blood vessel pattern of the individual would not be leaked. If the unique ID were to be leaked, operation of the system would be enabled by simply changing the reference patterns in the database 30 and reissuing the ID without re-registration of the finger blood vessel pattern.

By utilizing the above-described unique ID, privacy-protected type of authentication can be performed on the network server. Although biometric modality information may temporarily remain in the client terminal (i.e., the authentication processing unit 13) connected to the network when the biometric feature is scanned, safety can be ensured by completely erasing the information immediately after the unique ID is generated. Further, the ID generation unit of the authentication processing unit 13 may transmit the unique ID to the network 7 as encrypted. Encryption of the unique ID ensures that the biometric modality information will not be leaked. Should the unique ID be stolen, the unique ID can be changed and prevented from being abused by simply changing the rule for generating the unique ID from the biometric feature.

In the present embodiment, the unique ID is generated by encoding the blood vessel pattern in the finger blood vessel image. The ID may also be generated by encoding a geometric feature in a partial region of the finger blood vessel image, such as brightness gradient, blood vessel direction, the number of blood vessels or the shape thereof.

In the registration database 8 in the network 7, the unique ID is registered in advance, and the unique ID is collated with an input unique ID at the time of authentication to perform individual authentication. The unique ID has no risk of information leakage because the original biometric modality information cannot be extracted from the unique ID even if stolen on the network.

According to the first to the eighth embodiments, a highly accurate authentication system can be provided in a large-scale biometric authentication system.

The present invention is not limited to the foregoing embodiments, and may include various modifications. The embodiments have been described for the purpose of facilitating an understanding of the present invention, and are not limited to have all of the described configurations. A part of the configuration of one embodiment may be substituted by the configuration of another embodiment, or the configuration of the other embodiment may be incorporated into the configuration of the one embodiment. With respect to a part of the configuration of each embodiment, addition of another configuration, deletion, or substitution may be made.

The various computing units, such as the authentication processing unit 13 and the image input unit 18, may be implemented by software by having a processor interpret and execute a program for realizing the respective functions. The information for realizing the functions, such as programs, tables, and files, may be placed in a storage device such as a memory, a hard disk, or a solid state drive (SSD), or a recording medium such as an IC card, an SD card, or a DVD. The various computing units described above, such as the authentication processing unit 13 and the image input unit 18, may be implemented by hardware by designing a part or all of the units in an integrated circuit, for example.

The control lines and information lines shown in the drawings are those deemed necessary for description purposes, and do not necessarily represent all of control lines or information lines required in a product. All of the configurations may be mutually connected.

### DESCRIPTION OF SYMBOLS

6 Biometric feature information
6-1 First feature information
6-2 Second feature information
6-3 Third feature information
7 Network
8 Registration database
9 Extraction property
10 Authentication-requesting person
11 Registered person
12 Measurement device
13 Authentication processing unit
14 Storage device
15 Display unit
16 Input unit
17 Speaker
18 Image input unit
19 CPU
20 Memory
21 Interface
30 Database
101 Authentication unit
102 Registration unit

What is claimed is:

1. An authentication system comprising:
a measurement device that acquires biometric modality information from a living body of a first user;
an input unit that generates at least one item of input information from the biometric modality information;
a storage device that stores first feature information acquired from the biometric modality information of the first user, and second feature information acquired based on a correlation between the biometric modality information of the first user and biometric modality information of a second user; and
an authentication unit that authenticates the first user by collating the input information with the first feature information and collating the input information with the second feature information.

2. The authentication system according to claim 1, wherein the second feature information is feature information of which a correlation value indicating the correlation between the biometric modality information of the first user and the biometric modality information of the second user is higher than a predetermined reference value.

3. The authentication system according to claim 1, wherein the authentication unit calculates
a first score by collating the input information with the first feature information,
a second score by collating the input information with the second feature information, and
a final collation score by integrating the first score and the second score.

4. The authentication system according to claim 1, wherein the authentication unit collates the input information with the second feature information by searching for the second feature information in a range of the input information.

5. The authentication system according to claim 1, further comprising a registration unit that extracts, from the biometric modality information of each of the first and the second users that has been obtained by the measurement device, the first feature information and the second feature information concerning each user, and that stores the extracted information in the storage device.

6. The authentication system according to claim 1, wherein:
the storage device further stores property information for extracting, from the biometric modality information of the first user that has been acquired by the measurement device, second input information as the object of collation with the second feature information;
the input unit extracts, from the biometric modality information of the first user that has been acquired by the measurement device, the second input information using the property information; and
the authentication unit collates the second input information with the second feature information.

7. The authentication system according to claim 6, further comprising a registration unit that extracts, from the biometric modality information of each of the first and the second users that has been obtained by the measurement device, the first feature information, the second feature information, and the property information concerning each user, and that stores the first feature information, the second feature information, and the property information in the storage device.

8. The authentication system according to claim 1, wherein:
the storage device further stores, with respect to a group of at least three persons including the first user, group feature information acquired based on a correlation between the biometric modality information of the at least three persons; and
the authentication unit identifies the group to which the first user belongs by collating the input information with the group feature information.

9. The authentication system according to claim 1, further comprising:
a database storing a plurality of reference patterns; and
an ID generation unit that generates an ID on the basis of a similarity obtained from the biometric modality information of the first user that has been acquired by the measurement device and the plurality of reference patterns.

10. An authentication system comprising:
a measurement device that acquires biometric modality information from a living body of a first user;
an input unit that generates input information from the biometric modality information;
a storage device that stores, with respect to a group of at least three persons including the first user, group feature information acquired based on a correlation between the biometric modality information of the at least three persons; and
an authentication unit that authenticates the group to which the first user belongs by collating the input information with the group feature information.

11. The authentication system according to claim 10, wherein the group feature information is feature information of which a correlation value indicating the correlation between the biometric modality information of the at least three persons is higher than a predetermined reference value.

12. The authentication system according to claim 10, wherein the storage device further stores property information for extracting, from the biometric modality information of the first user that has been acquired by the measurement device, the input information as the object of collation with the group feature information for each of the at least three users;
the input unit extracts, from the biometric modality information of the first user that has been acquired by the measurement device, the input information using the property information; and
the authentication unit authenticates the group to which the first user belongs and the first user by collating the input information with the group feature information.

13. The authentication system according to claim 10, wherein:
the storage device further stores first feature information acquired from the biometric modality information of the first user; and
the authentication unit
authenticates a second user belonging to the group by collating the input information with the first feature information,
identifies the group to which the second user belongs, and
authenticates the first user by, when the first user is at a spatially close distance from the second user and temporally close to an authentication time of the second user, collating the input information with the group feature information, and collating the input information with the first feature information of a person belonging to the group.

14. The authentication system according to claim 10, wherein:
the storage device further stores first feature information acquired from the biometric modality information of the first user; and
the authentication unit authenticates the first user by collating, after the group is authenticated, the input information with the first feature information of a person belonging to the group.

15. An authentication system comprising:
a measurement device that acquires biometric modality information from a living body of a first user;
an input unit that generates input information from the biometric modality information;
a storage device that stores first feature information acquired from the biometric modality information of the first user and group information indicating a group to which the first user belongs; and
an authentication unit that authenticates the first user by collating the input information with the first feature information,
wherein the authentication unit
authenticates a second user belonging to the group by collating the input information with the first feature information,
identifies the group to which the second user belongs, and
lowers an authentication condition for the first user for a predetermined period of time when the first user is at a close spatial distance from the second user and temporally close to an authentication time for the second user.
